(19) United States
(12) Patent Application Publication
(10) Pub. No.: US 2025/0015526 A1
(43) Pub. Date: Jan. 9, 2025

(54) ELECTRICAL CONNECTOR SYSTEM INCLUDING A MALE TERMINAL HAVING A CONTACT ARM WITH A FOLDED PORTION

(71) Applicant: EATON INTELLIGENT POWER LIMITED, Dublin 4 (IE)

(72) Inventors: James Dawson, West Chicago, IL (US); Brantley Natter, Brightom, MI (US); Mohamad Zeidan, Bloomfield Hills, MI (US); Slobodan Pavlovic, ETOBICOKE (CA); Nathan Hollin, West Chicago, IL (US); Steve Krass, Saint Charles, IL (US)

(21) Appl. No.: 18/709,575

(22) PCT Filed: Dec. 5, 2022
(86) PCT No.: PCT/EP2022/025551

§ 371 Date: May 13, 2024

Related U.S. Application Data
(60) Provisional application No. 63/286,072, filed on Dec. 5, 2021.
(60) Provisional application No. 63/286,080, filed on Dec. 5, 2021.

(51) Int. Cl. H01R 13/17

(52) U.S. Cl. CPC H01R 13/17

(57) ABSTRACT

An electrical connector system having a male connector assembly and a female connector assembly. The male connector assembly includes a male housing and a male terminal assembly that includes a male terminal body and at least one contact arm with a folded or pleated portion that is formed from overlapping contact arm layers which increases the thickness of the contact arm at that portion and provides additional contact points with a spring member. The male terminal assembly also includes a spring assembly with both the spring member and a spring holder that are receivable in the male terminal body. The female connector assembly has a female housing and a female terminal assembly. The female terminal assembly comprises a female terminal connection member and a female terminal body. The female housing is designed to receive the female terminal assembly, facilitate the coupling of the male terminal assembly with the female terminal assembly, minimize the chance that a foreign object accidentally makes contact with the female terminal assembly, and help ensure that the connector system meets industry standards, such as USCAR specifications.

### RELATED APPLICATIONS

This application claims the benefit from U.S. provisional patent application Nos. 63/286,072 and 63/286,080, both of which were filed on Dec. 5, 2021, and are incorporated herein by this reference.

### FIELD OF DISCLOSURE

The present disclosure relates to an electrical connector system, more specifically a connector system having a male connector assembly and a female assembly. The male connector assembly includes, among other things, a male terminal and a spring assembly with both a spring member and a spring holder that are separable from the male terminal. The male terminal has at least one contact arm with a folded or pleated portion that provides additional contact points with the spring member and increases the thickness of said contact arm at that portion.

### BACKGROUND

Over the past several decades, the number of electrical components used in automobiles, and other on-road and off-road vehicles such as pick-up trucks, commercial vans and trucks, semi-trucks, motorcycles, all-terrain vehicles, and sports utility vehicles (collectively “motor vehicles”) has increased dramatically. Electrical components are used in motor vehicles for a variety of reasons, including but not limited to, monitoring, improving and/or controlling vehicle performance, emissions, safety and creates comforts to the occupants of the motor vehicles. Considerable time, resources, and energy have been expended to develop power distribution components that meet the varied needs and complexities of the motor vehicle market; however, conventional power distribution components suffer from a variety of shortcomings.

Motor vehicles are challenging electrical environments for both the electrical components and the connector assemblies due to several conditions, including but not limited to, space constraints that make initial installation difficult, harsh operating conditions, large ambient temperature ranges, prolonged vibration, heat loads, and longevity, all of which can lead to component and/or connector failure. For example, incorrectly installed connectors, which typically occur in the assembly plant, and dislodged connectors, which typically occur in the field, are two significant failure modes for the electrical components and motor vehicles. Each of these failure modes leads to significant repair and warranty costs. For example, the combined annual accrual for warranty by all of the automotive manufacturers and their direct suppliers is estimated to be between $50 billion and $150 billion, worldwide. In light of these challenging electrical environments, considerable time, money, and energy have been expended to find power distribution components that meet the needs of the markets. This disclosure addresses the shortcomings of conventional power distribution components. A full discussion of the features and advantages of the present disclosure is deferred to the following detailed description, which proceeds with reference to the accompanying drawings.

### SUMMARY OF THE INVENTION

The present disclosure relates to an electrical connector system having a male connector assembly and a female connector assembly. The male connector assembly includes a male housing and a male terminal assembly that includes a male terminal body and at least one contact arm with a folded or pleated portion that increases the thickness of said contact arm at that portion. The male terminal assembly also includes a spring assembly with both a spring member and a spring holder that are separable from the male terminal body.

According to another aspect, the connector assembly also includes a female connector assembly having a female housing and a female terminal assembly. The female terminal assembly comprises a female terminal connection member and a female terminal body. The female housing is designed to receive the female terminal assembly, facilitate the coupling of the male terminal assembly with the female terminal assembly, minimize the chance that a foreign object accidentally makes contact with the female terminal assembly, and help ensure that the connector system meets industry standards, such as USCAR specifications.

According to another aspect, the connector assembly is configured to omit the spring assembly whereby the male terminal assembly lacks a separate spring member and a spring holder. Due to the omission of these components, the male terminal includes: (i) sidewall portions that extend along a substantial length of the contact arms, (ii) an end extent which is coupled to the sidewall portions and extends around the diameter of the male terminal body, (iii) an internal spring member that is integrally formed as part of the male terminal body. To integrally form the internal spring member as inseparable part of the male terminal assembly, the entire terminal body is formed from a cladded material, such as copper clad steel, copper and stainless steel, or plating material, copper and steel or stainless steel.

Other aspects and advantages of the present disclosure will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of a first embodiment of a connector system in a disconnected state S_{DC}, showing a male terminal assembly disconnected from a female terminal assembly;

FIG. 2 is a perspective view of the male terminal assembly of FIG. 1;

FIG. 3 is an exploded view of the male terminal assembly of FIG. 2, showing a male terminal body, and a spring assembly with both a spring member and a spring holder;

FIG. 4 is a frontal perspective view of the male terminal body of FIG. 3;

FIG. 5 is a rear perspective view of the male terminal body of FIG. 3;

FIG. 6 is a side perspective view of the male terminal body of FIG. 3;

FIG. 7 is a zoomed-in view of a portion of the male terminal body shown in FIG. 6;

FIG. 8A is a front view of the male terminal body of FIG. 3;

FIG. 8B is a zoomed-in view of a contact arm of the male terminal body shown in FIG. 8A;

FIG. 9 is a first side view of the male terminal body of FIG. 3;

FIG. 10 is a second side view of the male terminal body of FIG. 3;

FIG. 11 is a cross-sectional view of the male terminal body taken along line 11-11 of FIG. 10;

FIG. 12 is a top view of the male terminal body of FIG. 3;

FIG. 13A is a cross-sectional view of the male terminal body taken along line 13A-13A of FIG. 12;

FIG. 13B is a zoomed-in view of a folded portion of a contact arm of the male terminal body shown in FIG. 13A;

FIG. 14 is a perspective view of the spring member of FIG. 3;

FIG. 15 is a side view of the spring member of FIG. 14;

FIG. 16 is a perspective view of the spring holder of FIG. 3;

FIG. 17 is a zoomed-in view of a portion of the spring holder shown in FIG. 16;

FIG. 18 is a side view of the spring holder of FIG. 3;

FIG. 19 is a cross-sectional view of the spring holder taken along line 19-19 of FIG. 18;

FIG. 20 is a perspective view of the spring assembly of FIG. 3 in a disjoined state S_{DJ}, showing the spring holder disjoined from the spring member;

FIGS. 21-22 are perspective views of the spring assembly of FIG. 3 in a joined state S_{J};

FIG. 23 is a front view of the spring assembly of FIGS. 21-22;

FIG. 24 is a cross-sectional view of the spring assembly taken along line 24-24 of FIG. 23;

FIG. 25 is a side view of the spring assembly of FIGS. 21-22;

FIG. 26 is a cross-sectional view of the spring assembly taken along line 26-26 of FIG. 25;

FIG. 27 is a side view of the spring assembly of FIGS. 21-22;

FIG. 28 is a cross-sectional view of the spring assembly taken along line 28-28 of FIG. 27;

FIG. 29 is a perspective view of the male terminal assembly of FIG. 3 in a disassembled state SDA, showing the male terminal body disassembled from the spring assembly;

FIG. 30 is a side view of the male terminal assembly of FIG. 3 in the assembled state SA;

FIG. 31 is a cross-sectional view of the male terminal assembly taken along line 31-31 of FIG. 30;

FIG. 32 is a zoomed-in view of an area of the male terminal assembly of FIG. 31;

FIG. 33 is a side view of the male terminal assembly in the assembled state S_{A};

FIG. 34 is a cross-sectional view of the male terminal assembly taken along line 34-34 of FIG. 33;

FIG. 35 is a side view of the male terminal assembly in the assembled state S_{A};

FIG. 36 is a perspective cross-sectional view of the male terminal assembly taken along line 36-36 of FIG. 35;

FIG. 37 is a cross-sectional view of the male terminal assembly taken along line 37-37 of FIG. 35;

FIG. 38 is a front view of the male terminal assembly in the assembled state S_{A};

FIG. 39 is a cross-sectional view of the male terminal assembly taken along line 39-39 of FIG. 38;

FIG. 40 is a zoomed-in view of an area of the male terminal assembly of FIG. 39, showing a folded portion of a contact arm of the male terminal body;

FIG. 41 is a side view of the male terminal assembly in the assembled state S_{A}, including dimensions thereof;

FIG. 42 is a front view of the male terminal assembly in the assembled state S_{A}, including dimensions thereof;

FIG. 43 is a perspective view of the female terminal assembly of FIG. 1;

FIG. 44 is a front view of the female terminal assembly of FIG. 43;

FIG. 45 is a side view of the connector system of FIG. 1 in a connected state S_{CN}, wherein the female housing assembly has been omitted;

FIG. 46 is a cross-sectional view of the connector system taken along line 46-46 of FIG. 45;

FIG. 47 is a side view of the connector system of FIG. 1 in the connected state S_{CN};

FIG. 48 is a cross-sectional view of the connector system taken along line 48-48 of FIG. 47;

FIG. 49 is a front view of a second embodiment of a spring assembly of the male terminal assembly;

FIG. 50 is a cross-sectional view of the second embodiment of the spring assembly taken along line 50-50 of FIG. 49;

FIG. 51 is a side view of a third embodiment of a spring assembly of the male terminal assembly;

FIG. 52 is a perspective cross-sectional view of the spring assembly taken along line 52-52 of FIG. 51;

FIG. 53 is a zoomed-in view of an area of the spring assembly of FIG. 52;

FIG. 54 is a diagram showing a vehicle, an AC charging system, and a DC charging system, wherein the AC charging system and DC charging system have at least one charge coupler and at least one socket;

FIG. 55 is perspective view of the charging system of FIG. 54, where the charge coupler is disconnected from the socket and includes at least one male terminal assembly;

FIGS. 56A-56I are different connection configurations of the charge coupler of FIG. 55;

FIG. 57 is a top view of an in-line fuse assembly that includes a plurality of connector systems;

FIG. 58 is a cross-sectional view of the in-line fuse assembly taken along line 58-58 of FIG. 57;

FIG. 59 is a perspective view of a battery pack having a plurality of the connector systems to electrically connect components of the battery pack;

FIG. 60 is a perspective view of a vehicle skateboard chassis with the battery pack of FIG. 59, as well as wheels and tires;

FIG. 61 is a perspective view of a motor vehicle having the skateboard chassis and battery pack of FIG. 60;

FIG. 62 is a perspective view of a fourth embodiment of a connector system in a disconnected state S_{DC}, showing a male terminal assembly disconnected from a female terminal assembly;

FIGS. 63-64 are perspective views of the male terminal assembly of FIG. 62;

FIG. 65 is a front view of the male terminal assembly of FIG. 62;

FIG. 66 is a side view of the male terminal assembly of FIG. 62;

FIG. 67 is a perspective cross-sectional view of the male terminal assembly taken along line 67-67 of FIG. 66;

FIG. 68 is a side view of the male terminal assembly of FIG. 62;

FIG. 69 is a cross-sectional view of the male terminal assembly taken along line 69-69 of FIG. 68;

FIG. 70 is a side view of the male terminal assembly of FIG. 62;

FIG. 71 is a cross-sectional view of the male terminal assembly taken along line 71-71 of FIG. 70;

FIG. 72 is a zoomed-in view of a folded portion of a contact arm of the male terminal assembly shown in FIG. 71;

FIG. 73 is a side view of the connector system of FIG. 62 in a connected state S_{CN}, wherein the female housing assembly has been omitted;

FIG. 74 is a cross-sectional view of the connector system taken along line 74-74 of FIG. 73;

FIG. 75 is a side view of the connector system of FIG. 62 in the connected state S_{CN};

FIG. 76 is a cross-sectional view of the connector system taken along line 76-76 of FIG. 75;

FIGS. 77A-77H are exemplary cross-sections of cladding materials that may be used to form an extent of the male terminal assembly of FIG. 62;

FIG. 78 is a perspective view of a fifth embodiment of a male terminal assembly;

FIG. 79 is a side view of a sixth embodiment of a male terminal assembly for a connector system; and

FIG. 80 is a cross-sectional view of the male terminal assembly taken along line 80-80 of FIG. 79.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

While this disclosure includes several embodiments in many different forms, it should be understood that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified without departing from the scope of the disclosed methods and systems. For example, one or more of the following embodiments, in part or whole, may be combined consistently with other disclosed methods and systems. Accordingly, the drawings and detailed descriptions are to be regarded as illustrative in nature, not restrictive or limiting.

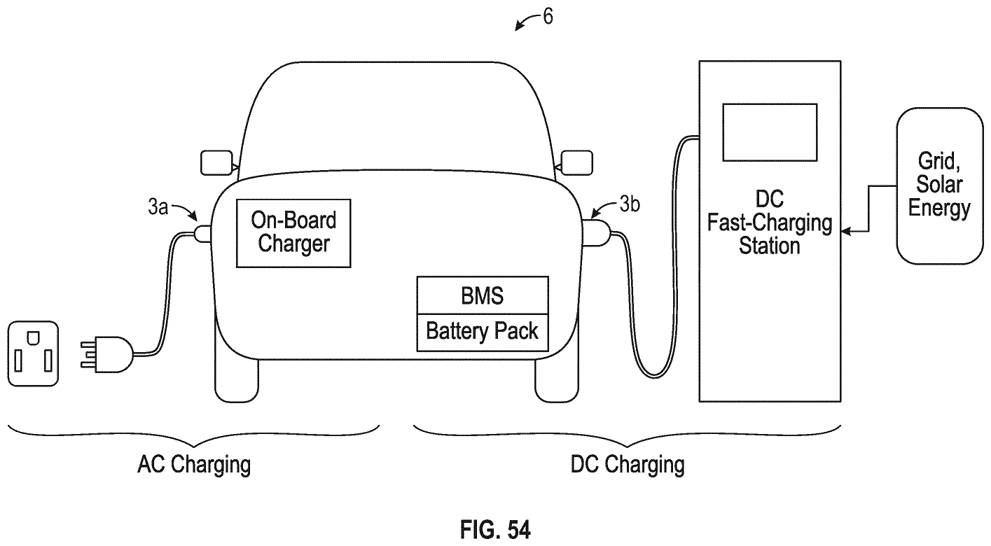

The Figures show six embodiments of a connector system 10, 1010, 2010, 3010, 4010, 5010 or components thereof designed to mechanically and electrically couple one device or component to another device or component within a power distribution system or environment. For example, a first device or component can be removable coupled to a second device or component via the connector system 10. The first device or component may be a current supplying device or component-such as charge coupler 2 (see FIGS. 54-56), alternator, battery, or another power source—while the second device or component may be a current drawing device or component-such as socket 4 (see FIGS. 54-56), radiator fan, heated seat, power distribution component, or another current drawing component.

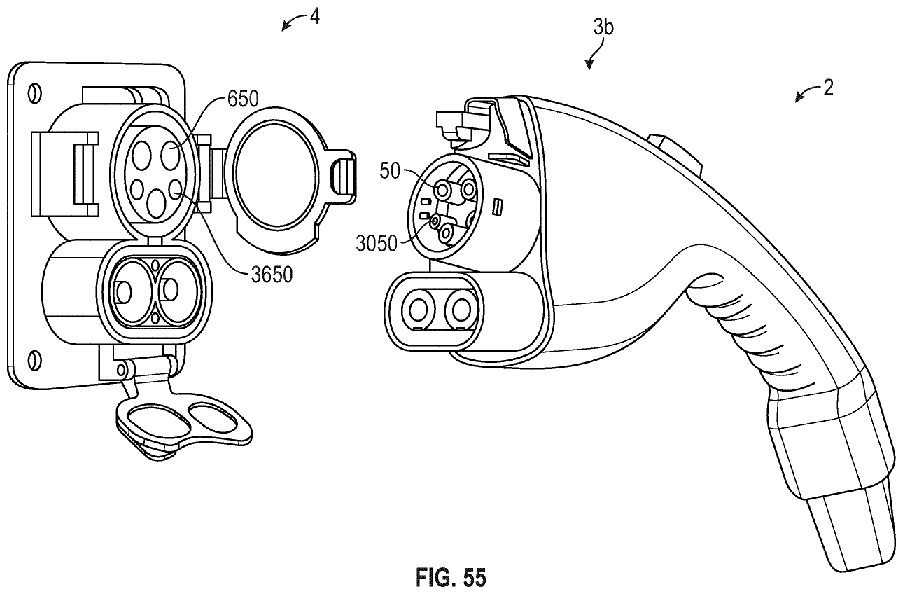

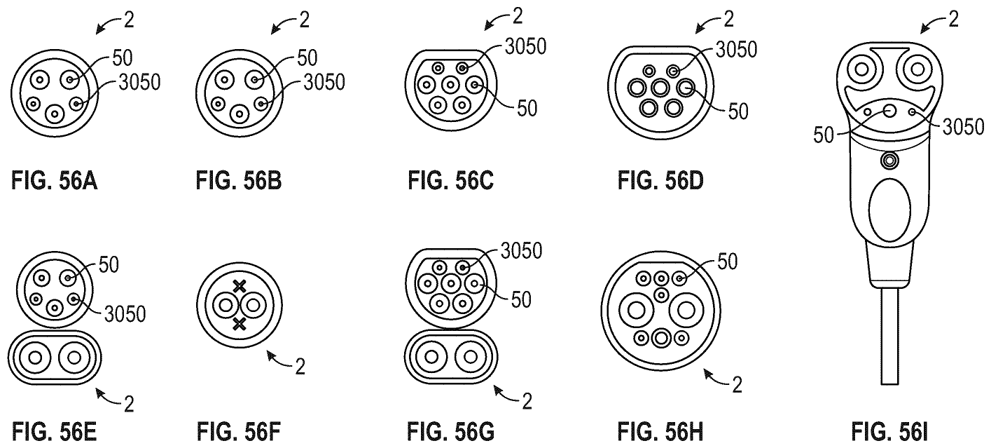

An exemplary power distribution system is provided in FIG. 54 which shows a vehicle 6, an AC charging system 3a, and a DC charging system 3b, wherein the AC and DC charging systems 3a, 3b have at least one charge coupler 2 and at least one socket 4. The charge couplers 2 and the sockets 4 are matched to one another such that an extent of the charge coupler 2 can be received by the socket 4. In FIG. 55, the charge coupler 2 may include three male connector assemblies 50 and two male connector assemblies 3050. Additionally, the charge coupler 2 may include two male connector assemblies that are disclosed in PCT/US18/19787, PCT/US19/36010, or PCT/US21/43788. Meanwhile, the socket 4 may include three female connector assemblies 650 and two female connector assemblies 3650. Additionally, the socket 4 may include two female connector assemblies that are disclosed in PCT/US18/19787, PCT/US19/36010, or PCT/US21/43788. When the charge coupler 2 is connected to the socket 4: (i) connection signals can travel between the fourth embodiment of the male and female terminal connectors 3050, 3650 to inform the charging systems 3a, 3b of a proper connection between the coupler 2 and socket 4, (ii) AC power can flow between first embodiment of the male and female connector assemblies 50, 650, (iii) one of the first embodiment of the male and female connector assemblies 50, 650 can function as a ground for the system 3a, 3b, and (iv) DC power can flow between the male and female connector assemblies disclosed in PCT/US18/19787, PCT/US19/36010, or PCT/US21/43788. FIGS. 56A-56I show alternative configurations of charge couplers 2 that may include on or more than one of the connectors assemblies disclosed herein.

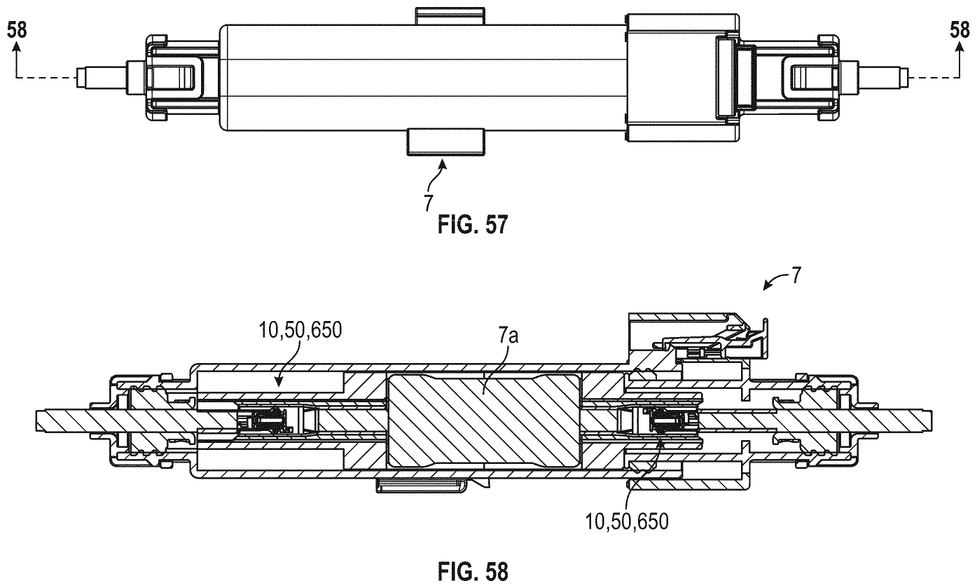

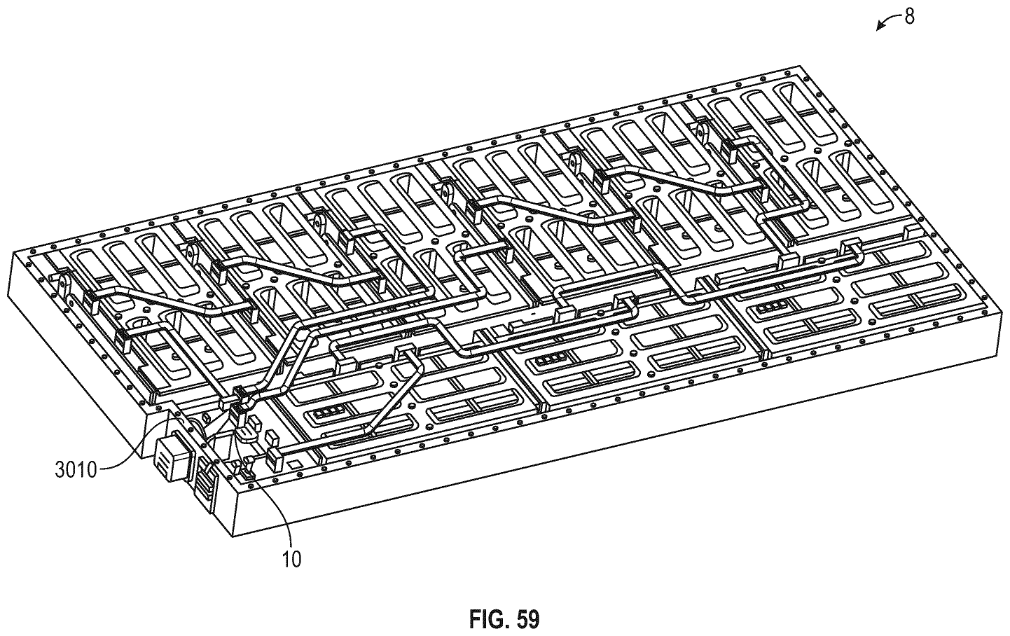

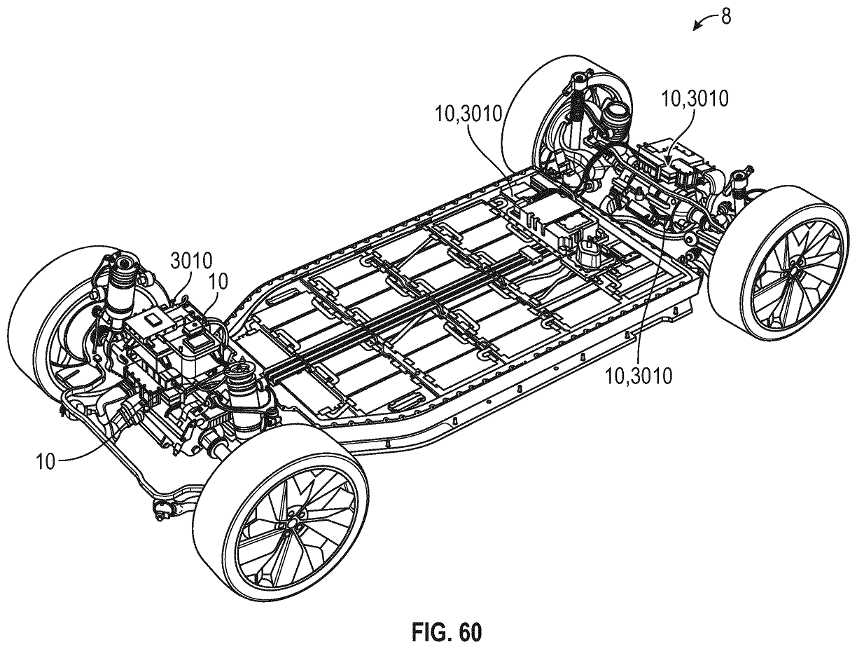

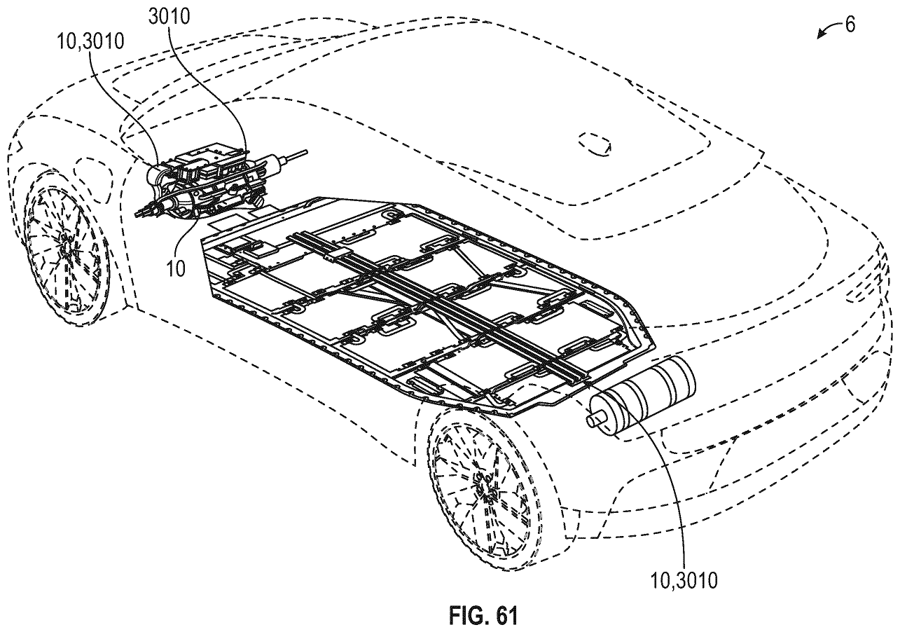

As another example, one or more connector systems 10 may be utilized within a single device or component. For example, two connector systems 10 may be utilized in an in-line fuse assembly 7, as shown in FIGS. 57-58. For example, two of the connector systems 10 may be utilized in an in-line fuse 7 application. In this example, electrical current can flow from the male terminal assembly 50 through the female terminal assembly 650, into the fuse 7a, through the first embodiment of the female terminal assembly 650, and out the first embodiment of the male terminal assembly 50. A power distribution system or environment that includes the connector system 10 may be installed within an airplane, vehicle skateboard 9, motor vehicle 6, a military vehicle (e.g., tank, personnel carrier, heavy-duty truck, and troop transporter), a bus, a locomotive, a tractor, a boat, a submarine, a battery pack 8, a 24-48 volt system, for a high-power application, for a high-current application, for a high-voltage application.

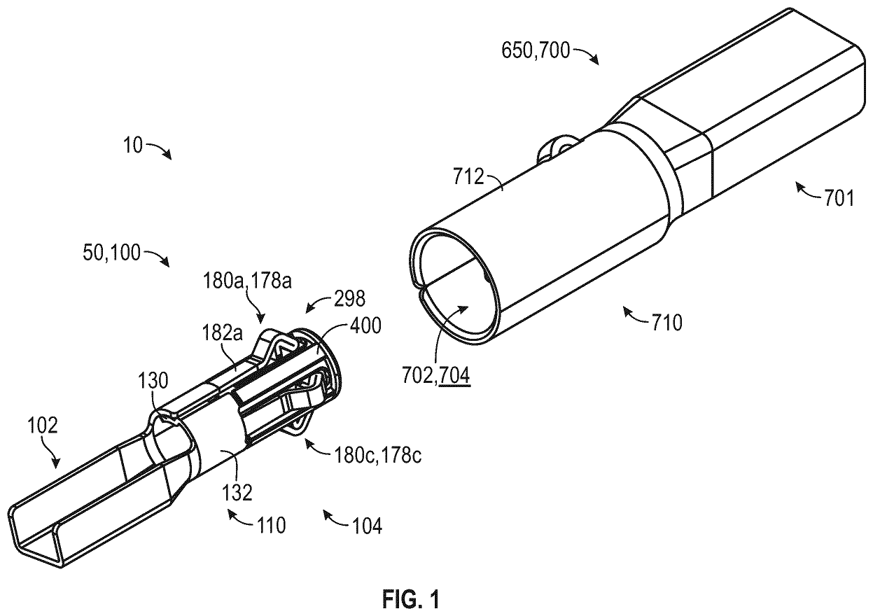

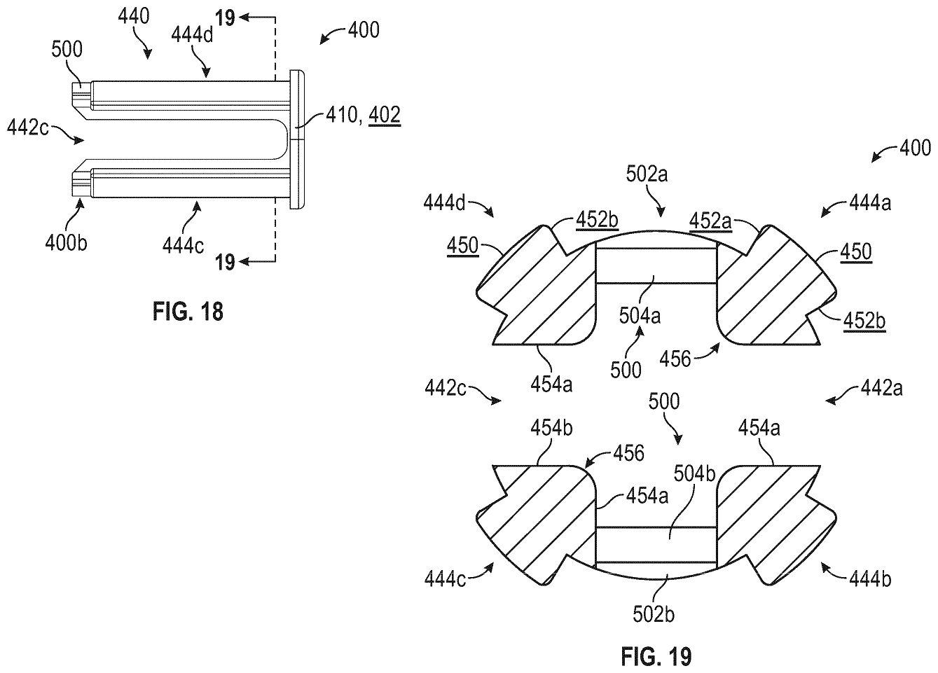

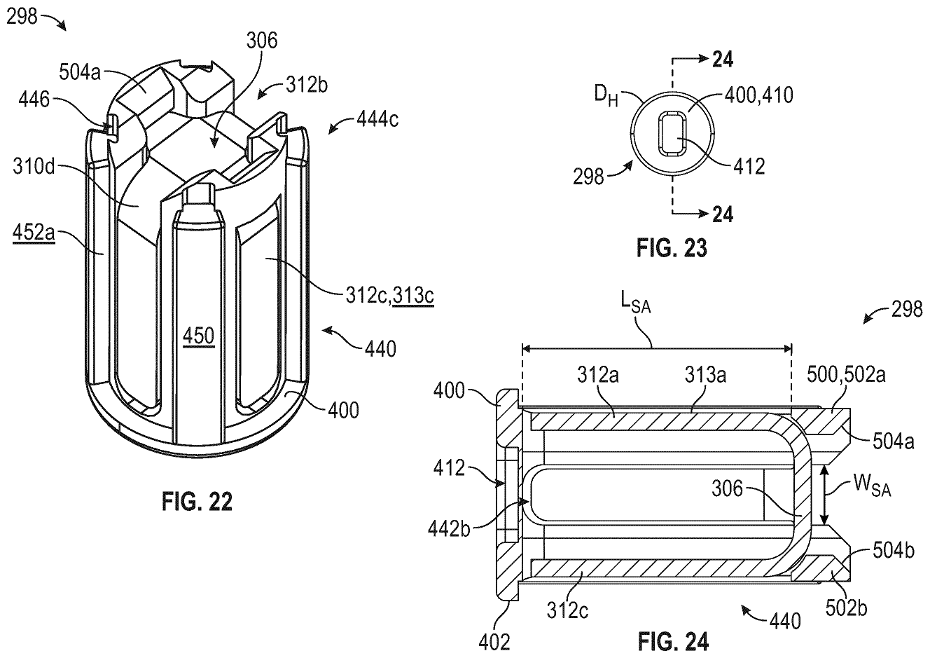

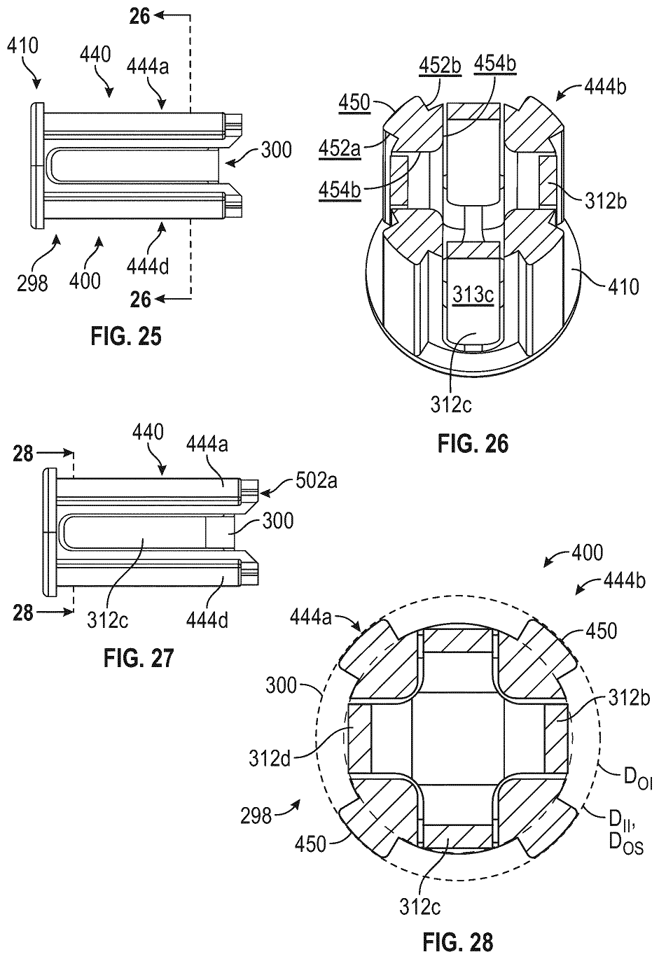

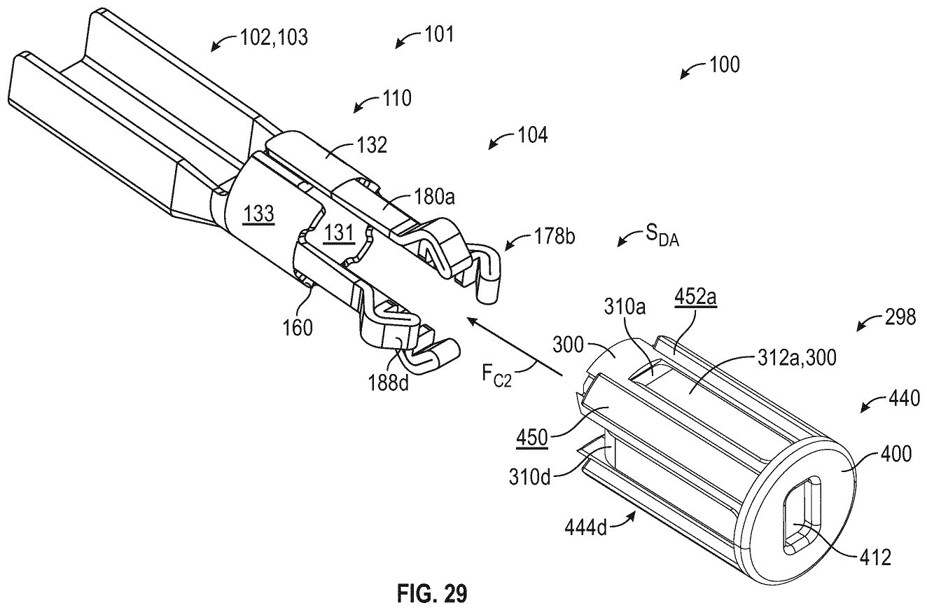

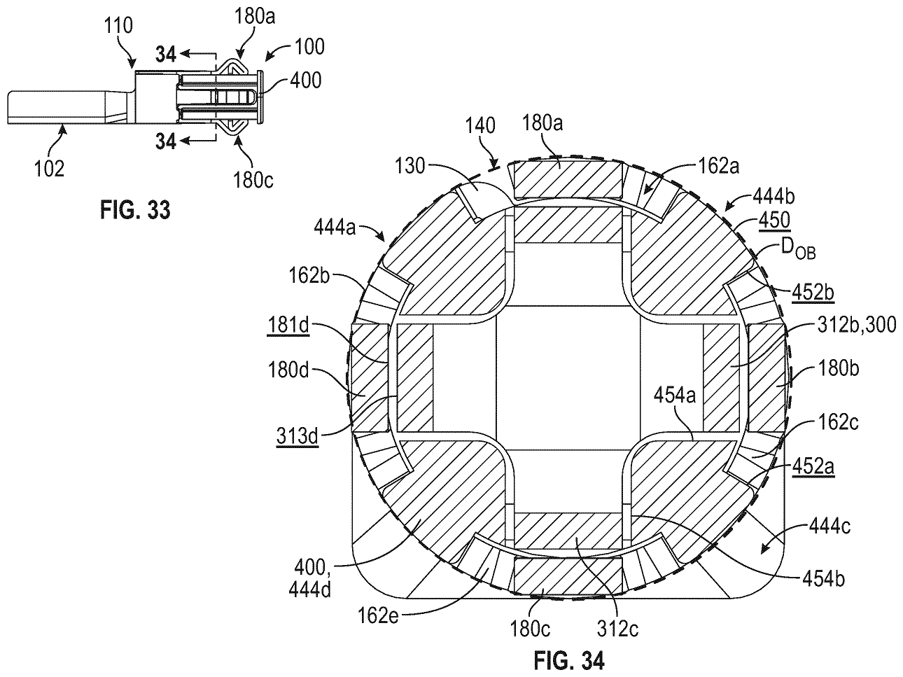

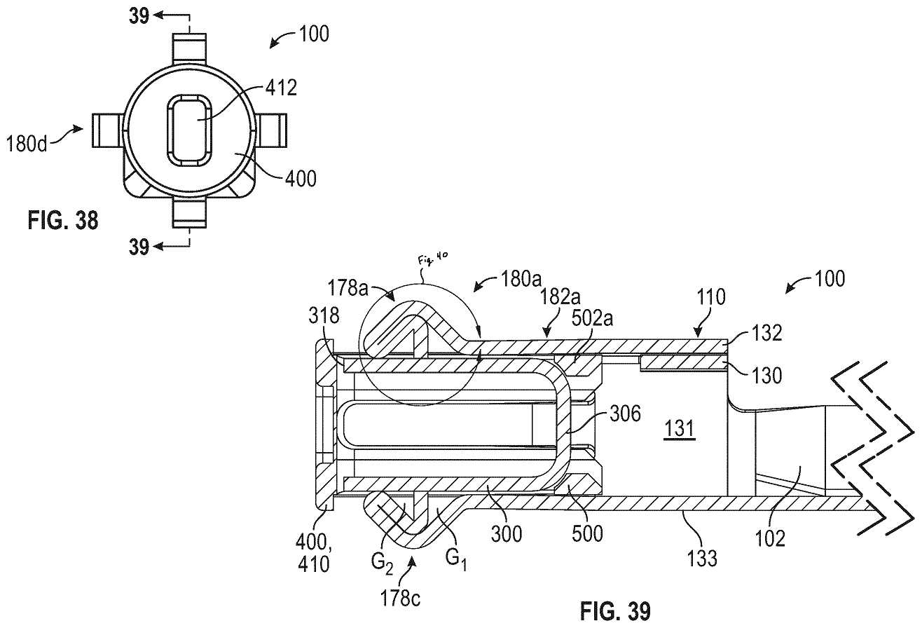

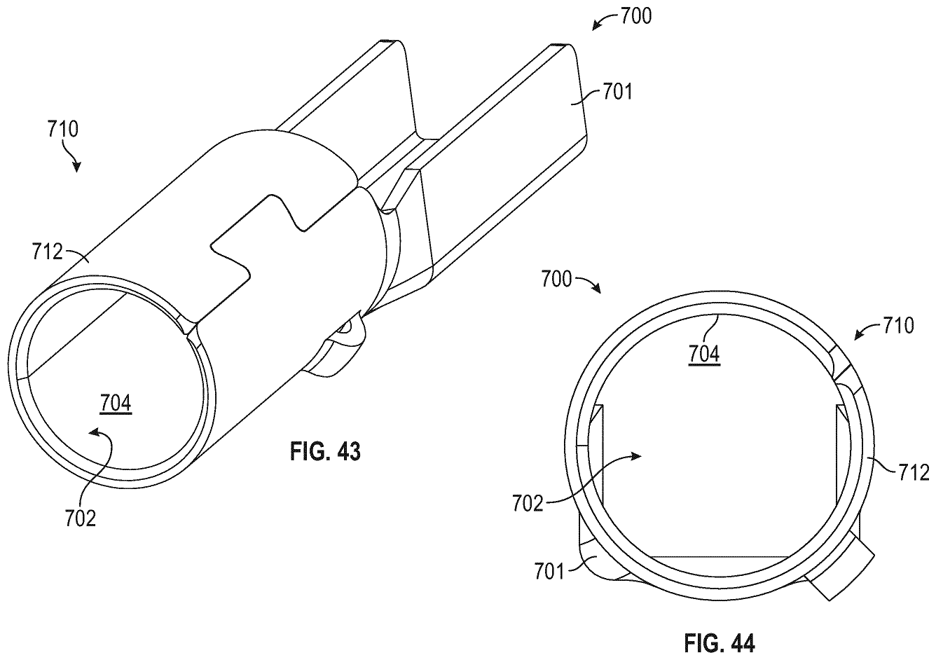

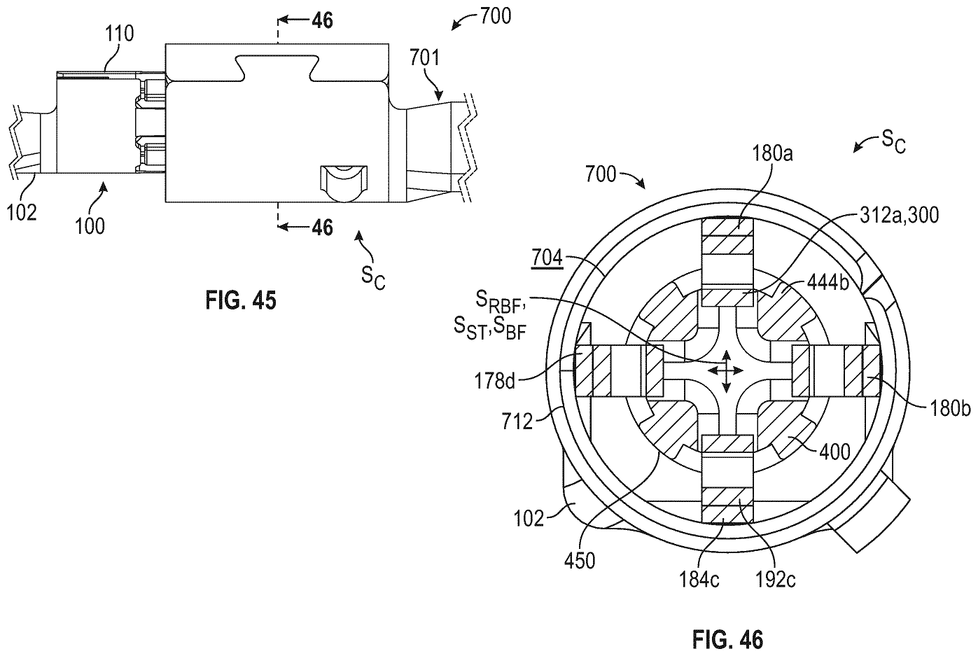

Various aspects of a first embodiment of the connector system 10 are explained in greater detail below. In general terms, the connector system 10 comprises: (i) a male connector assembly 50, and (ii) a female connector assembly 650. FIGS. 1-42 and 45-48 show various views and components of the male connector assembly 50. The first embodiment of the male connector assembly 50 primarily comprises: (i) a male housing assembly (not shown) and (ii) a male terminal assembly 100 having a male terminal 101 and a spring assembly 298. FIGS. 43-48 show various views of the first embodiment of the female connector assembly 650, which primarily comprises: (i) a female housing assembly 670 and (ii) a female terminal assembly 700.

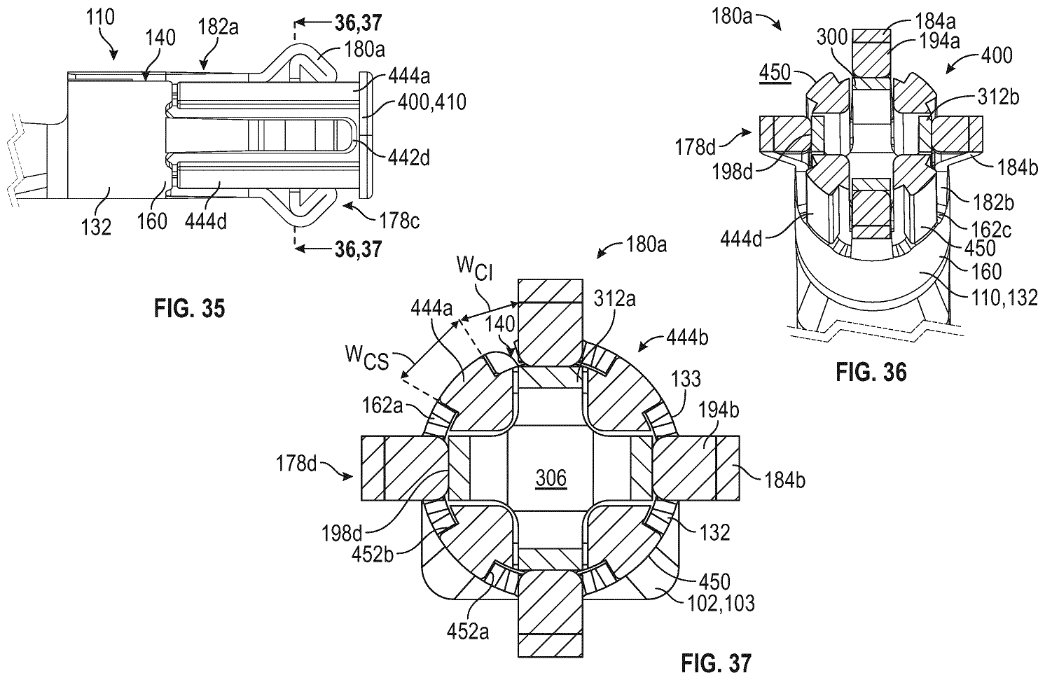

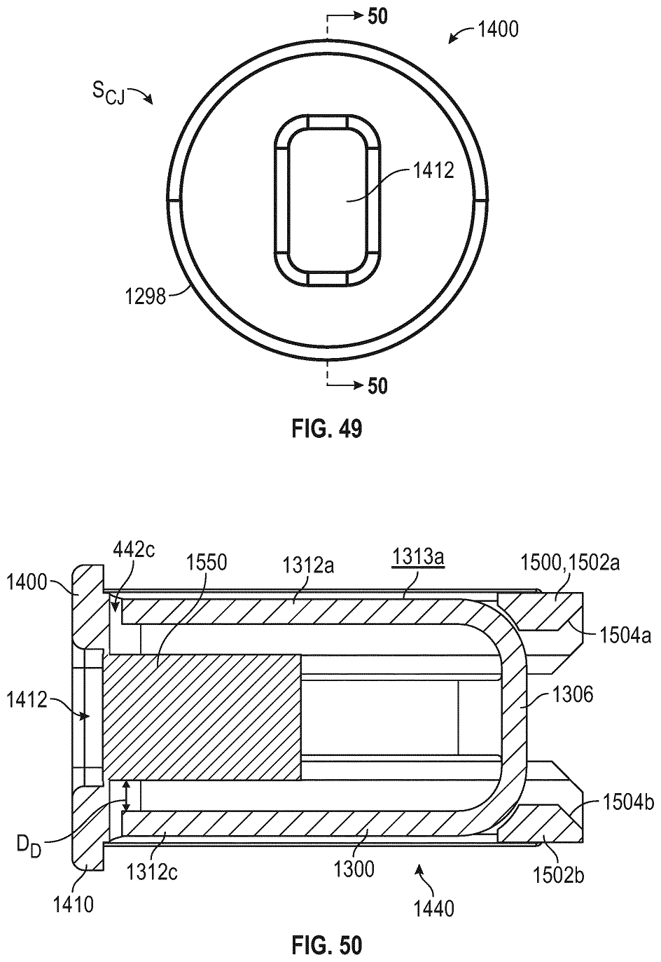

The first embodiment of the connector system 10 provides numerous improvements over conventional connectors. Some of these improvements include: (i) a male terminal body 104 that includes a base portion 110 and at least one contact arm 180a-180d with an initial extent 182a-182d that is substantially co-planar with said base portion 110, (ii) said male terminal body 104 lacks intermediate conductive structures that are positioned between the contact arms 180a-180d and extend along a substantial length of said contact arms 180a-180d, (iii) said contact arms 180a-180d have a unique folded or pleated configuration with directly overlapping contact arm layers that creates two contact points 196a-196d, 198a-198d with the spring member 300, (iv) said contact arms 180a-180d do not include recesses that significantly alter the width of the contact arm 180a-180d between two different locations on the contact arm 180a-180d, (v) the base portion 110 of the male terminal body 104 includes an interlocking member 130 and positioning projections 160, (vi) as shown in at least FIG. 35, the spring holder 400 includes an a first or head portion 410 with an outer, peripheral surface 402 that is flush with both: (a) an external surface 133 of the base portion 110 of the male terminal body 104, and (b) an initial extent 182a-182d of the contact arms 180a-180d, and (vii) the outer perimeter of the male terminal assembly 100 includes alternating conductive and non-conductive structures. While the foregoing list includes some of the numerous improvements that are included in the first embodiment of the connector system 10, it should be understood that other improvements are disclosed herein and that each and every improvement disclosed herein is not necessary or essential to the configuration, operation, or functionality of the disclosed connector system 10. Other similar embodiments of the connector system 10 are disclosed in FIGS. 49-53, wherein said other embodiments show alternative configurations of the spring assembly 1298 and 2298 that may be used in connection with the first embodiment of the male terminal 101.

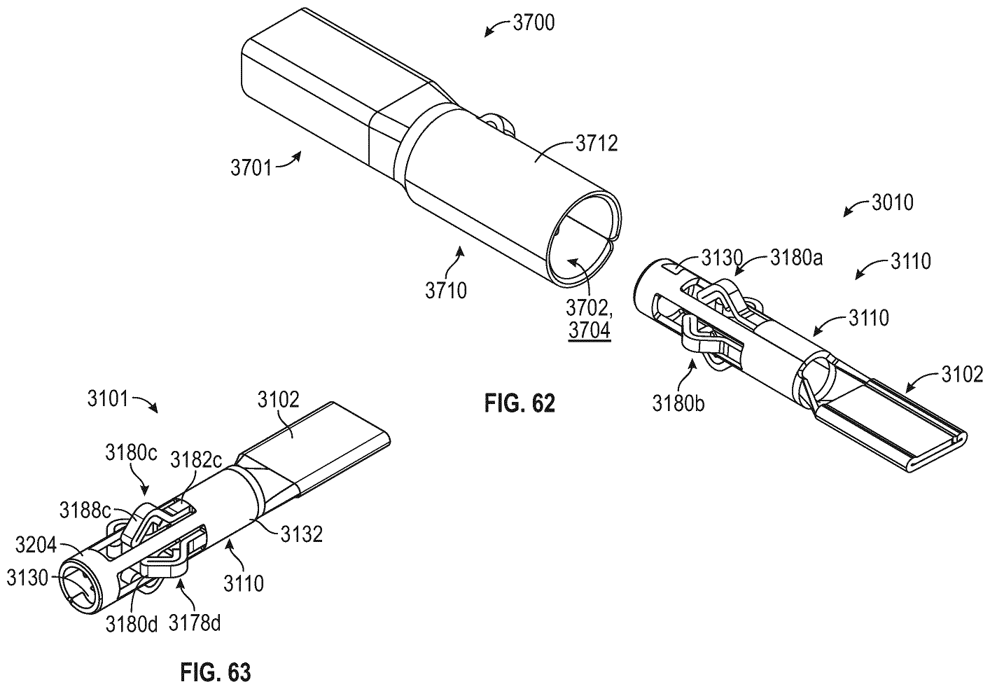

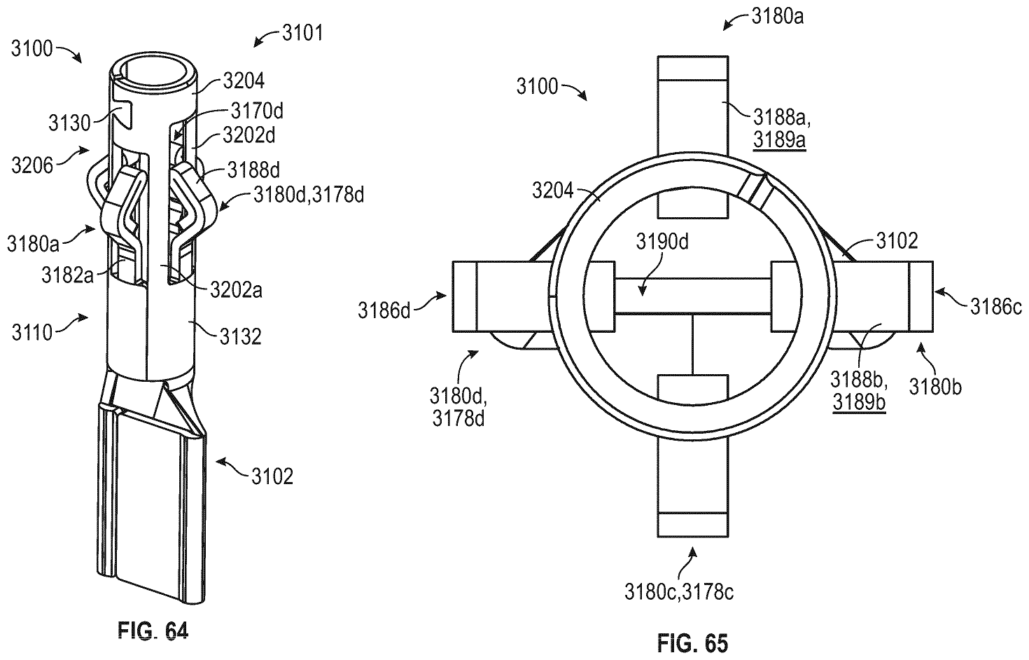

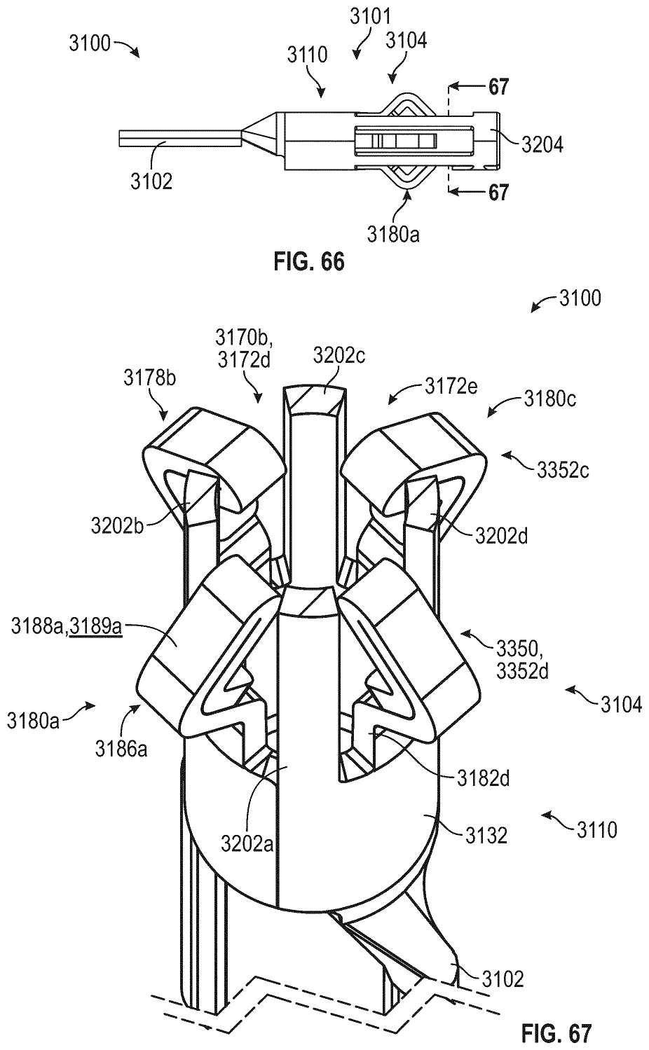

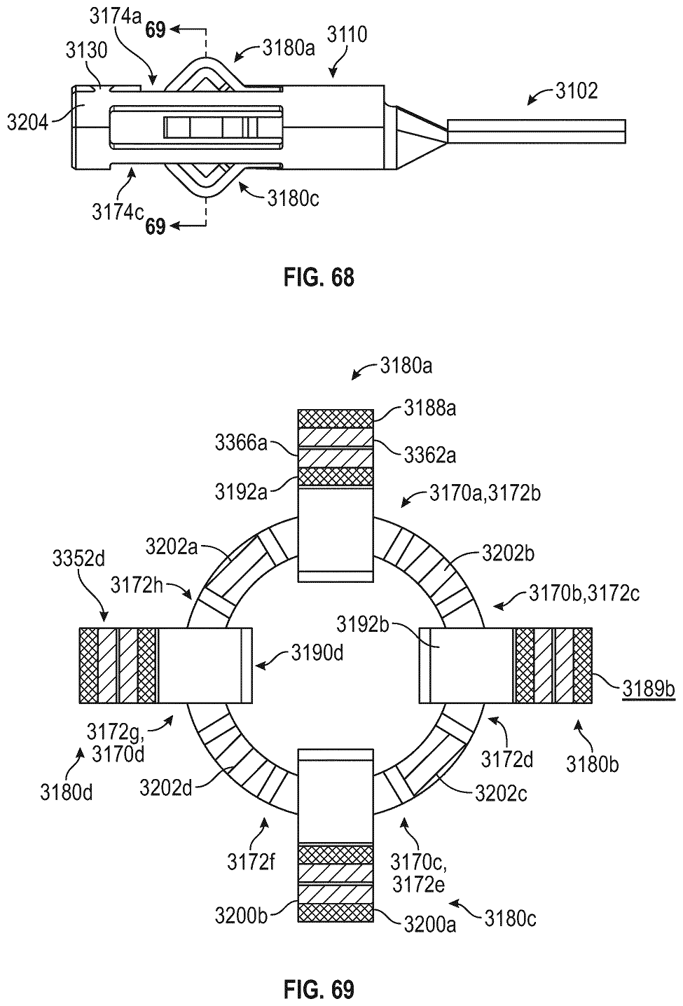

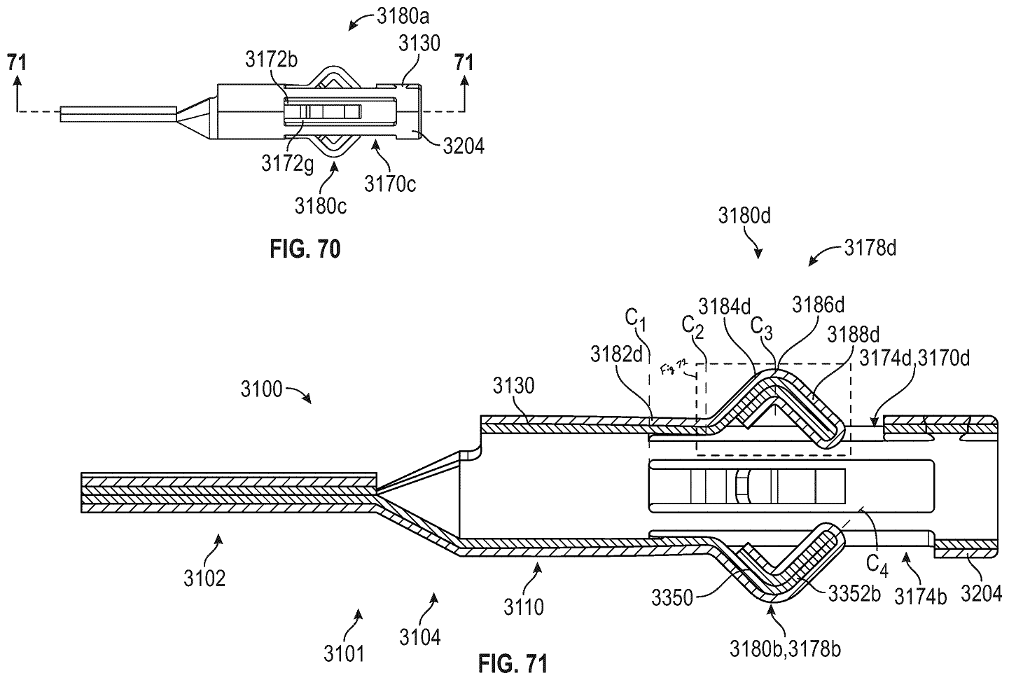

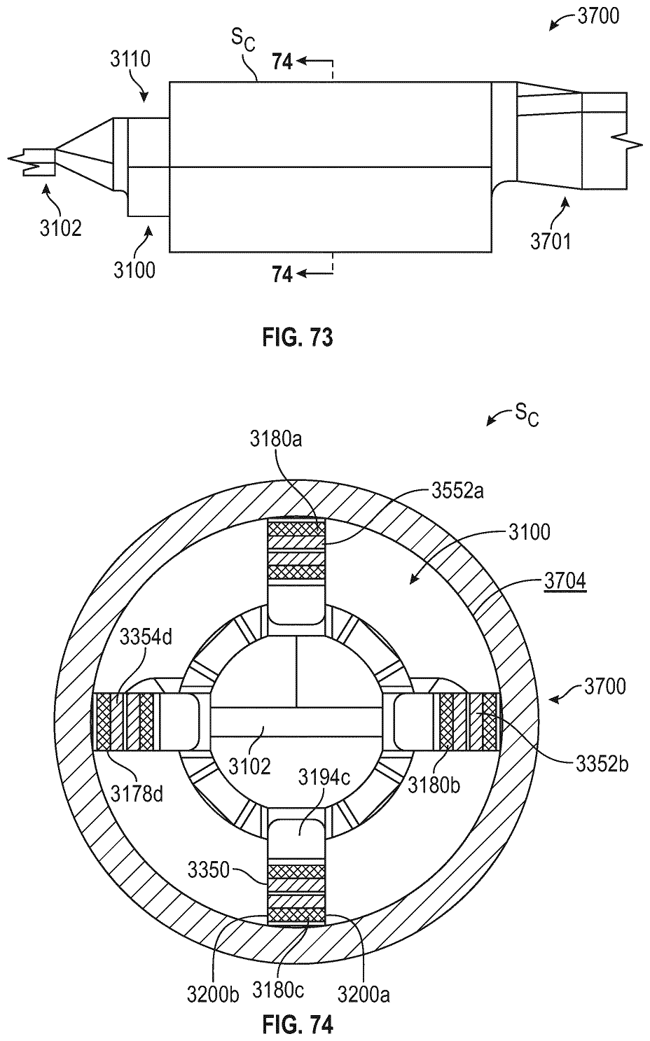

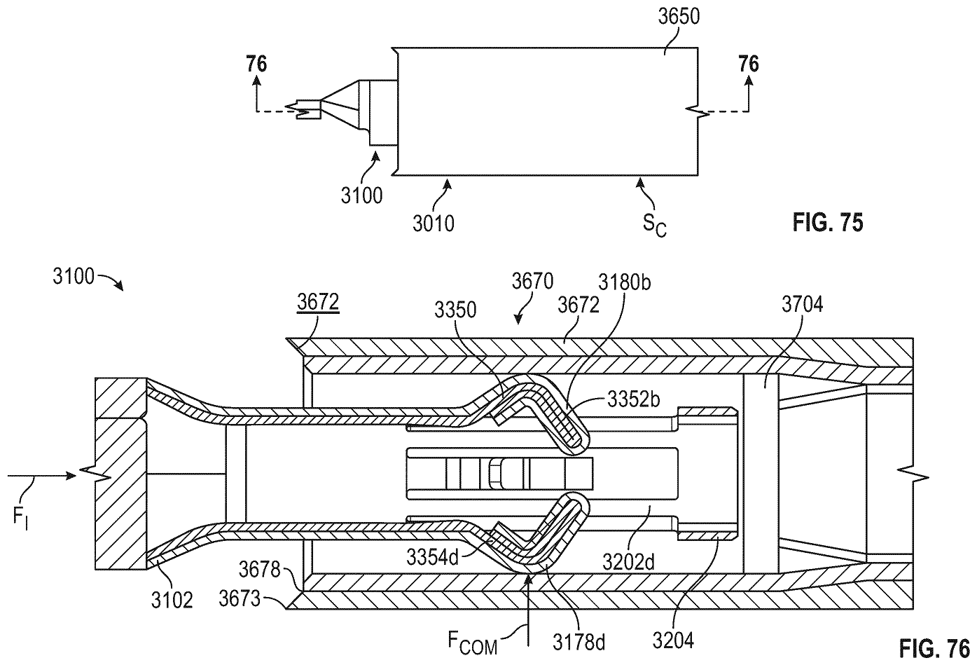

Various aspects of a fourth embodiment of the connector system 3010 is disclosed herein. Specifically, the connector system 3010 comprises: (i) a male connector assembly 3050, and (ii) a female connector assembly 3650. FIGS. 62-76 show various views and components of the male connector assembly 3050. The fourth embodiment of the male connector assembly 3050 is primarily composed of: (i) a male housing assembly (not shown) and (ii) a male terminal assembly 3100 having a male terminal 3101 and an internal, integrally formed, spring member 3350 that is not separable from the male terminal after the male connector assembly 3050 is formed. FIGS. 73-76 show various views of the first embodiment of the female connector assembly 3650, which is primarily composed of: (i) a female housing assembly 3670 and (ii) a female terminal assembly 3700. The connector system 3010 provides numerous improvements over conventional connectors. Some of these improvements include: (i) a male terminal body 3104 that includes a base portion 3110 and a contact arm 3180a-3180d with an initial extent 3182a-3182d that is substantially co-planar with said base portion 3110, (ii) a male terminal assembly 3100 that lacks a separate and distinct spring member, (iii) a male terminal assembly 3100 formed from a cladded material, which may include copper and steel, (iv) the contact arms 3180a-3180d do not include recesses that significantly alter the width of the contact arm 3180a-3180d between two different locations on the contact arm 3180a-3180d, (v) the end extent 3204 of the male terminal body 3104 that includes an interlocking member 3130. While the foregoing list includes some of the numerous improvements that are included in the fourth embodiment of the connector system 3010, it should be understood that other improvements are disclosed herein and that each and every improvement disclosed herein is not necessary or essential to the configuration, operation, or functionality of the disclosed connector system 3010. Other similar embodiments of the connector system 3010 are disclosed in FIGS. 78-80, wherein said other embodiments show alternative configurations of the male terminal assembly 3100 and over-travel or over-compression protection projection 4550.

### First Embodiment

### 1) Male Connector Assembly

The male connector assembly 50 includes multiple components designed to be coupled to a separate device or component (e.g., in-line fuse 7, charge coupler 2, radiator fan, heated seat, power distribution component, or another current drawing component). The male connector assembly 50 is primarily composed of: (i) the male housing assembly 70, and (ii) the male terminal assembly 100 with the male terminal 101 and the spring assembly 298, wherein during operation of the connector system 10 at least a substantial extent of the male terminal assembly 100 resides within the male housing assembly.

a. Male Housing Assembly

Referring to FIG. 48, the male housing assembly 70 may include an arrangement of side walls that are formed from a non-conductive plastic and surround an extent of the male terminal assembly 100 in the connected state S_{C}. The male housing assembly 70 may include: (i) a connector position assurance (CPA) assembly that includes a readable or scannable indicia, which meets USCAR Specifications, including USCAR-12, USCAR-25, and USCAR-2, (ii) a keyed configuration, wherein the male connector assembly 50 can only mate with the female connector assembly 650 when the male connector assembly 50 is in a specific orientation relative to the female connector assembly 650, (iii) an EMI shield, (iv) additional layers of non-conductive and/or conductive materials, and/or (vi) a larger footprint (e.g., charge coupler 2 shown in FIGS. 55-56) to accept multiple male terminal assemblies 50. Other similar male housing assemblies are disclosed in applications incorporated herein by reference, and features of these housing assemblies may be incorporated into the male housing assembly 70 for the male terminal assembly 100 disclosed herein.

b. Male Terminal

FIGS. 1-42 and 45-48 provide various views of the male terminal assembly 100. Referring to the first embodiment, the male terminal assembly 100 includes the male terminal 101 and the spring assembly 298. The male terminal 101 includes a male terminal connection member 102 and a male terminal body 104. Specifically, the male terminal connection member 102 is coupled to the male terminal body 104. In this embodiment, the male terminal connection member 102 is a wire receiver 103, wherein said wire receiver 103 has a U-shaped receptacle that is configured to receive an extent of an external structure (e.g., lead or wire) that connects the male terminal assembly 100 to a device (e.g., an alternator) external to the connector system 10. A wire is typically welded to the wire receiver 103; however, other methods (e.g., forming the wire as a part of the wire receiver 103) of connecting the wire to the wire receiver 103 are contemplated by this disclosure. In other embodiments, the male terminal connection member 102 may be a blade, a crimp, a circuit board connector, or any other type of connection member 102 that mechanically and electrically couples the male terminal body 104 to an external device, part, or extent.

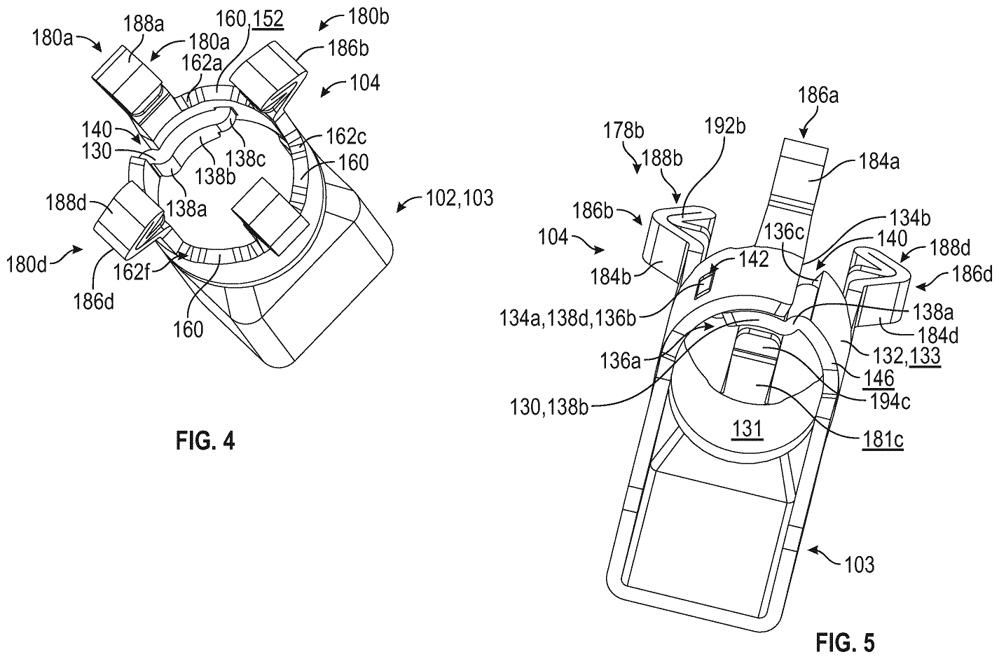

FIGS. 3-13 show that the male terminal body 104 includes: (i) a base or intermediate portion 110, (ii) at least one and preferably a plurality of contact arms 180a-180d extending from the base 110, and (iii) at least one and preferably a plurality of contact arm openings or voids 280a-280d, where an opening or void 280a-d is formed between a pair of contact arms 180a-d. As best shown in FIGS. 4-13, the base or intermediate portion 110 includes a single circular side wall 132 with: (i) a multi-segmented first end 134a having a rear extent 136a, an intermediate extent 136b, and a forward extent 136c, and (ii) a second end 134b. The multi-segmented first end 134a allows for the formation of the interlocking member 130. The interlocking member 130 is designed to prevent undesired mechanical movement, such as thermal expansion, of the male terminal body 104 during operation of the connector system 10. By preventing undesired mechanical movement or thermal expansion of the male terminal body 104, the connector 10 minimizes changes in the insertion force F_{I} associated with the system 10. For example, if the interlocking member 130 was omitted and another feature did not constrain the male terminal body 104, the distance between the contact arms 180a-180d could increase. The increase in the distance between the contact arms 180a-180d could then cause the connector system 10 to: (i) fail to meet USCAR specifications for insertion force F_{I}, (ii) cause the contact arm 180a-180d to be bent due to stubbing of the contact arm 180a-180d, and/or (iii) cause the male terminal assembly 100 to damage an extent of the female terminal assembly 700.

To prevent, or at least constrain or limit, undesired mechanical movement or thermal expansion of the male terminal body 104 during operation of the connector system 10, the interlocking member 130 is integrally formed with the side wall 132 and: (i) extends from a surface associated with the forward extent 136c of the multi-segmented first end 134a, (ii) includes a gap segment 138a, an internal segment 138b, and a mating segment 138c. In particular, the gap segment 138a extends from one of the interior walls 140a, 140b of the gap 140 that is formed between the forward extent 136c of the multi-segmented first end 134a and the second end 134b. The internal segment 138b is positioned between the gap segment 138a and the mating segment 138c and underlies an extent of the side wall 132. Finally, the mating segment 138c is designed to be received within the mating opening 142 formed in the side wall 132 and includes a free end 138d that is positioned substantially flush with the outer surface 133 of the base portion 110. While the interlocking member 130 is integrally formed with the side wall 132 in the disclosed embodiment, it should be understood that the interlocking member 130 may not be integrally formed with the side wall 132 in other embodiments. In other embodiments, interlocking member 130 may take a different form or configuration. For example, the interlocking member 130 may be replaced with an extent of the male terminal housing, a collar that surrounds an extent of the outer surface 133 of the base portion 110 of the male terminal body 104, a structure formed a part of the spring holder 400, or any structure that extends between inner extents of the base portion 110 of the male terminal body 104.

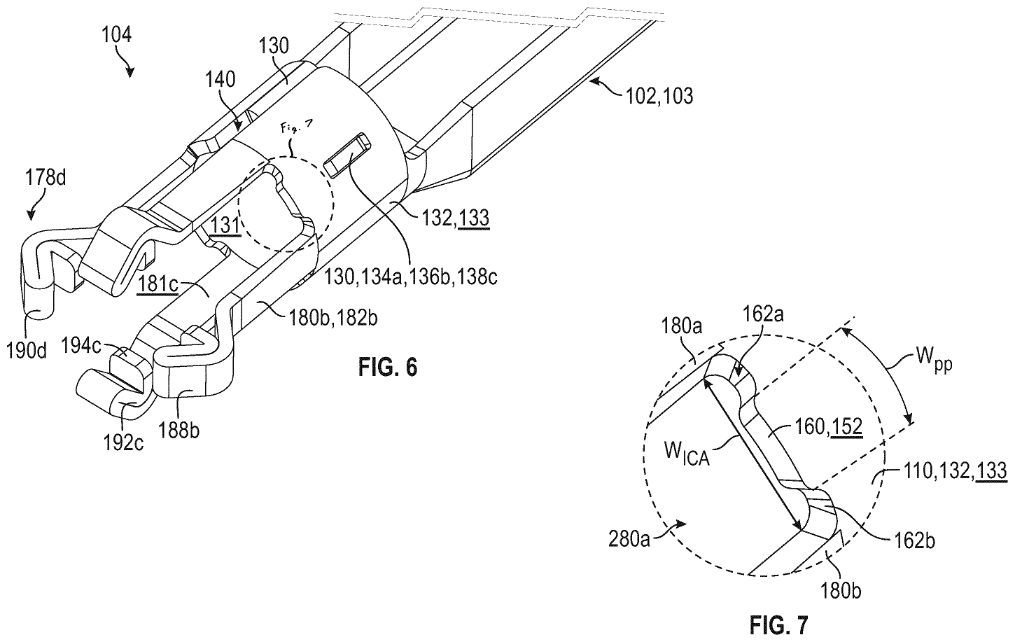

The base portion 110 of the male terminal body 104 also includes a rear surface 146 and a frontal surface 152. The rear and frontal surfaces 146, 152 are preferably parallel with one another and are preferably perpendicular to an extent of the outer surface 133 of the side wall 132. The rear surface 146 extends around only an extent of the base portion 110 because said portion is integrally formed with the male terminal connection member 102. The frontal surface 152 has an irregular configuration due to the contact arms 180a-180d and the positioning projections 160. Said positioning projections 160 are substantially centered between the contact arms 180a-180d and are configured to cooperatively interact (or abut) with the spring holder 400, namely, at least one positioning rib 444, when said spring holder 400 is inserted into the male terminal body 104. As shown in FIGS. 6 and 7, the positioning projections 160 do not fully extend between the contact arms 180a-180d; instead, the positioning projections 160 are flanked with notches 162a-162g. Said notches 162a-162g are designed to: (i) improve stamping tool reliability and robustness, (ii) reduce the likelihood that the contact arms 180a-180d will fail, such as crack, under severe stresses, and (iii) improve the roundness or circularity of the base portion 110 in comparison to a base portion that lacked these projections. While the inclusion of these benefits is desired, it should be understood that the designer may forgo these benefits by omitting the notched extents 162a-162g and extending the positioning projections 160 between two contact arms 180a-180d. It should be understood that omitting the notched extents 162a-162g and extending the positioning projections 160 would alter the configuration of the frontal surface 152.

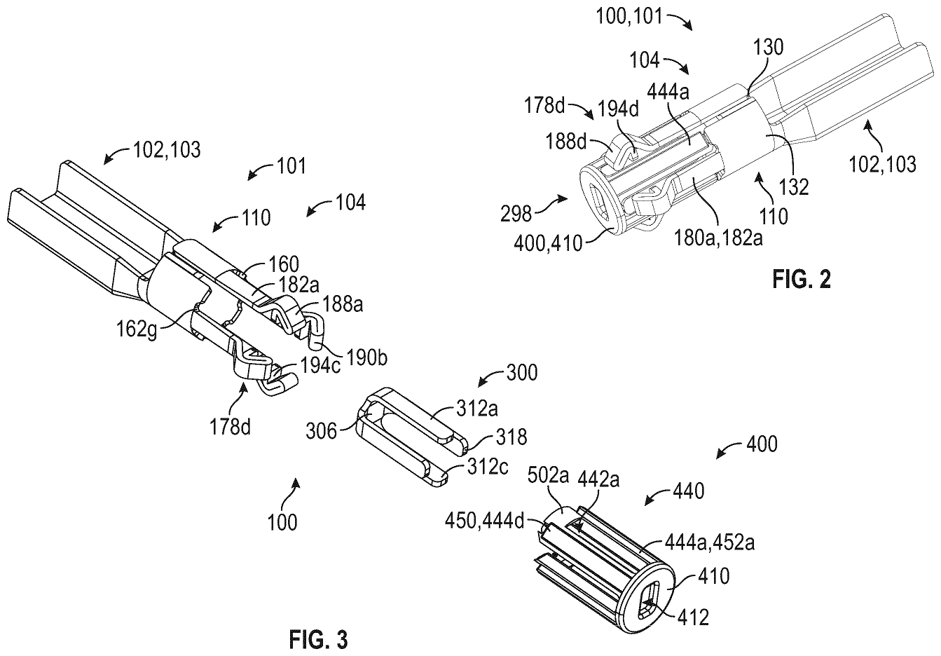

As best shown in FIGS. 2-13, the contact arms 180a-180d extend from the base or intermediate portion 110 and are radially spaced apart from one another along the perimeter of said base portion 110 to form a spring assembly receptacle 105. The radial spacing is arranged such that another contact arm 180a-180d could be positioned between a pair of contact arms 180a-180d. In the embodiment shown in these Figures, the contact arm opening 280a-280d has an internal width W_{ICA} that is larger than the width W_{CA} of the contact arm 180a-180d. In other words, the internal contact arm width W_{ICA} is approximately 2 mm, while the contact arm width W_{CA} is 1.2 mm. Additionally, the contact arm opening 280a-280d has an external width W_{ECA} (e.g., 4.15 mm) that is over three times larger than the width W_{CA} (e.g., 1.2 mm) of the contact arm 180a-180d. This radial spacing relationship helps ensure that the spring arms 312a-312d and contact arms 180a-180d do not contact each other during the operation or use of the system 10. Additionally, this radial spacing allows for the inclusion of the positioning ribs 444a-444d to be located between the pairs of contact arms 180a-180d, which helps protect the contact arms 180a-180d and increases the robustness of the system 10.

Referring specifically FIGS. 9-13, the contact arms 180a-180d have an initial or rear extent 182a-182d that extends from the base or intermediate portion 110 (line C₁) and a folded or pleated portion 178a-178d. The folded or pleated portion 178a-178d includes compound folds where a first layer of the contact arm 180a-d directly overlaps a second layer of the contact arm 180a-d wherein: (i) a second or upwardly sloping extent 184a-184d that extends between the initial extent 182a-182d (line C₂) and an exterior apex 186a-186d (line C₃) of the contact arm 180a-180d, (ii) a third or downwardly sloping extent 188a-188d that extends downward from an external apex 186a-186d (line C₃) to a forward-most extent that provides a frontal end or nose 190a-190d (line C₄) with a rounded or curvilinear end configuration, (iii) a fourth or rearwardly extending extent 192a-192d that extends rearward and upward from the forward-most extent 190a-190d (line C₄) to an interior apex 193a-193d (line C₅), and (iv) a fifth or vertical extent 194a-194d that extends inwardly from the interior apex 193a-193d (line C₅), preferably substantially perpendicular to a midpoint of the interior apex 193a-d. These extents and apexes provide the contact arms 180a-180d with a folded or pleated configuration whereby the third extent 188a-d overlaps the fourth extent 192a-d and the external apex 186a overlaps the internal apex 193a-d. Further, the pleated configuration of the contact arms 180a-d forms: (i) a frontal spring contact segment 196a-196d positioned near the forward-most frontal end or nose 190a-190d and within the fourth or rearwardly extending extent 192a-192d, and (ii) an intermediate spring contact segment 198a-198d being a part of the fifth or vertical extent 194a-194d.

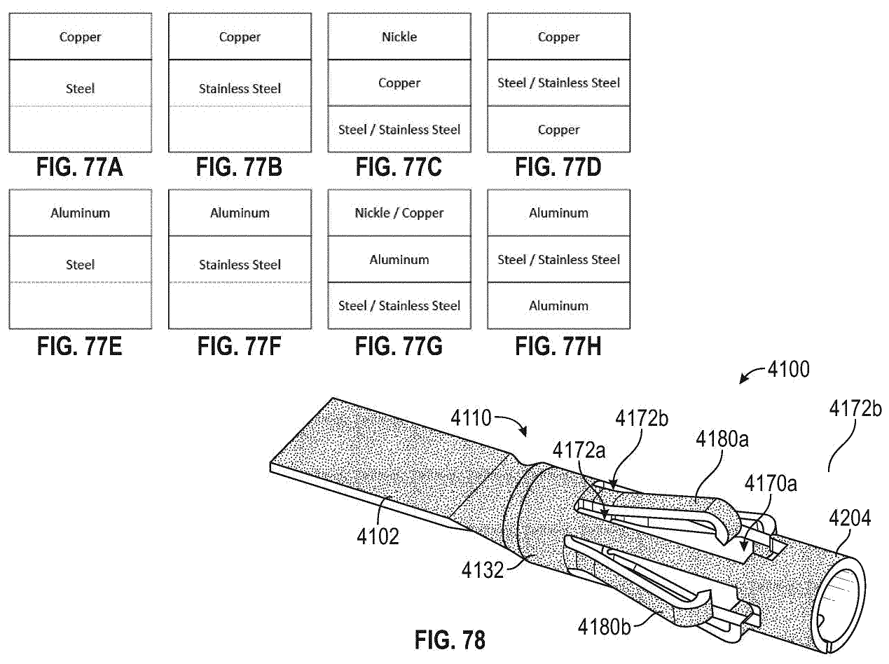

The folded or pleated configuration of the contact arms 180a-180d provides the connector system 10 with several advantages over previous designs. For example, this design includes a vertical extent 194a-194d that supports the external apex 186a-186d of said contact arm 180a-180d. This added support increases the durability of the contact arm 180a-180d over the contact arm 180a-180d designs shown in PCT/US2019/036010-namely, the designs shown in FIGS. 69-86—which is beneficial due to the small size of the contact arms 180a-180d. Additionally, having the frontal spring contact segment 196a-196d and the intermediate spring contact segment 198a-198d helps distribute the compressive force F_{COM} applied to the spring arms 312a-312d, when the male terminal assembly 100 is inserted into the female terminal assembly 700. Further, the configuration of the third or downward sloping extent 188a-188d is beneficial over contact arm designs shown in FIGS. 69-96 of PCT/US2019/036010 because its design helps reduce: (i) insertion forces due to the ramped contact arm design (in contrast to the circular contact arm design), and (ii) potential bending or stubbing of contact arms 180a-180d, when the insertion of the male terminal assembly 100 is not directly in line with the female terminal assembly 700.

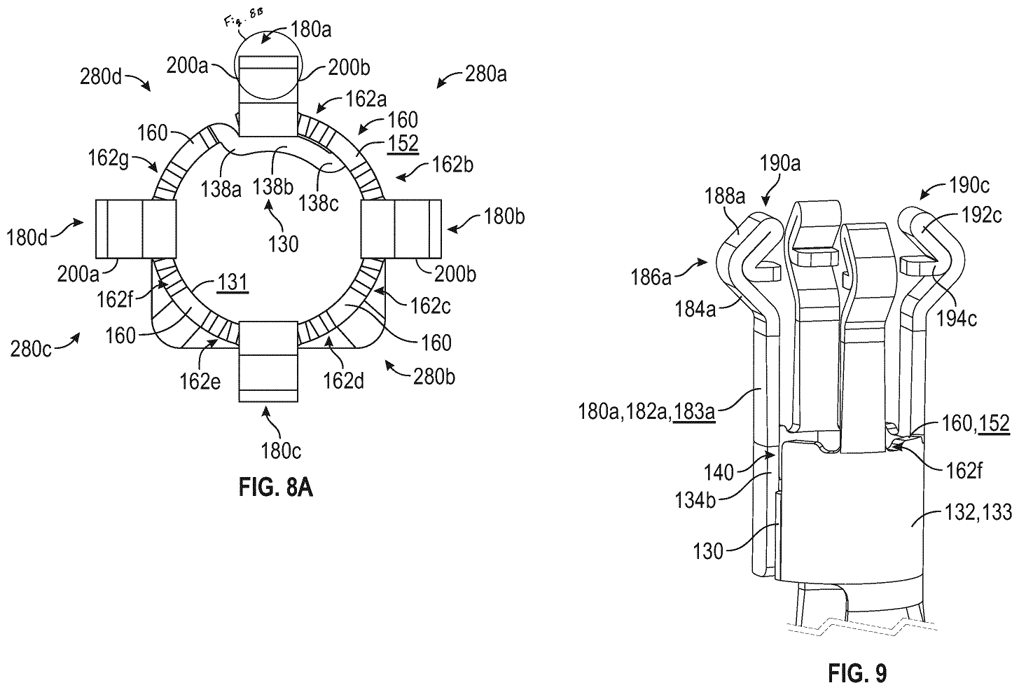

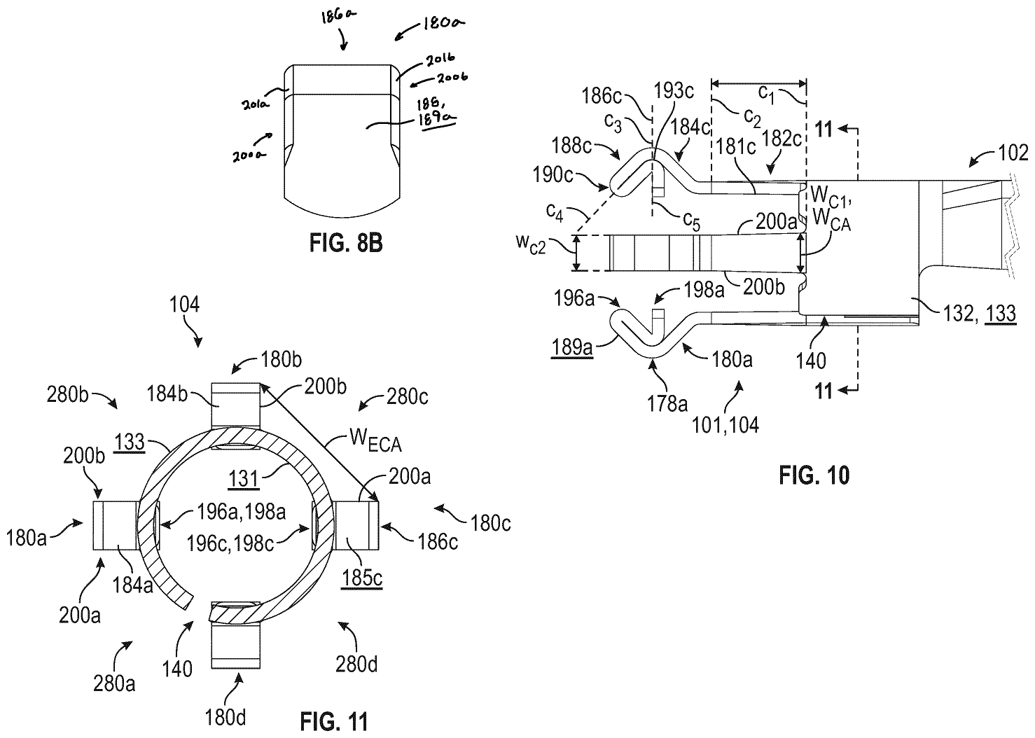

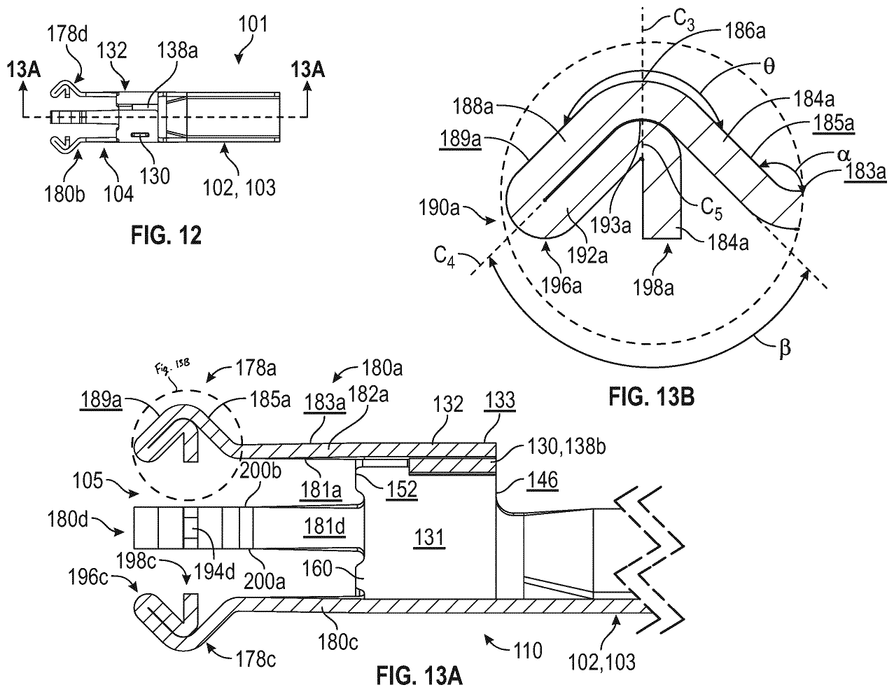

Referring to FIGS. 8-13, unlike conventional connectors, the disclosed contact arms 180a-180d have an elongated initial or rear extent 182a-182d that does not extend away from the base portion 110 at a uniform outward sloping angle or substantially uniform outward sloping angle. In other words and as best shown in FIGS. 12 and 13a, an outer surface 183a-183d of the initial or rear extent 182a-182d of each contact arm 180a-180d are: (i) substantially parallel with one another, and (ii) substantially aligned with the outer surface 133 of the corresponding extent of the base portion 110. Compared to conventional connectors that lack this elongated initial or rear extent 182a-182d, less force is required to deform or displace the contact arm 180a-180d inward or toward the center of the male terminal 101. This reduced force allows for an increase in the force required to inwardly displace an extent of the spring member 300. Shifting the structure that resists the inward displacement from the contact arm 180a-180d to the spring arm 312a-312d is beneficial because changes to the insertion force F_{I} can be easily made by changing the design and/or material composition of the spring member 300 and not redesigning the terminal body 104. For example, the designer can insert a stiffer spring member 300 in order to maintain/maximize the current carrying capacity of the system 10. Or if there are specific customer requirements setting forth a target insertion force F_{I}, the designer can select a spring member 300 that meets these requirements without having to undertake a costly and time-consuming redesign of the male terminal body 104. This modularity and flexibility of the connector system 10 is a substantial improvement over the prior art, as reduce the number of product SKUs, increases the ability to meet customer requirements without retooling or redesigning the connector, and/or limits testing and other steps that would be required to utilize new/different connectors. It should be understood that the length of the initial or rear extent 182a-182d will substantially alter the insertion force F_{I} required to insert the male terminal assembly 100 into the female terminal assembly 700. Also, in other embodiments, the contact arms 180a-180d may extend away from the base 110 at a uniform inwardly angle or substantially uniform inwardly sloping angle. Said inwardly sloping angle allows the male terminal assembly 100 to have an inwardly tapered design or configuration. In this alternative embodiment, the inwardly tapered design or configuration may be configured such that the outer diameter at line C₂ may be between 0.01% and 5% less than the outer diameter at line C₁.

As shown in FIGS. 13B, forward of the lateral initial or rear extent 182a-182d, the second or upwardly sloping extent 184a-184d is positioned at an outward angle alpha α that is defined between an outer surface 183a-183d of the initial or rear extent 182a-182d of the contact arm 180a-180d and an outer surface 185a-185d of the second or upwardly sloping extent 184a-184d of the contact arm. The outward angle alpha α is between 115 and 170 degrees, and preferably between 125 and 145 degrees. Forward of the second or upwardly sloping extent 184a-184d, the contact arm 180a-180d has a third or downwardly sloping extent 188a-188d that extends downward from the exterior apex 186a-186d to the forward-most frontal end or nose 190a-190d. An exterior angle theta θ is defined between the outer surface 185a-185d of the second or upwardly sloping extent 184a-184d and the outer or contact surface 189a-189d of the third or downwardly sloping extent 188a-188d. The exterior angle theta θ is between 240 and 300 degrees, and preferably between 255 and 285 degrees. Also, an interior angle beta β defined between the inner surface of the second or upwardly sloping extent 184a-184d and the inner surface of the third or downwardly sloping extent 188a-188d is between 60 and 120 degrees, and preferably between 75 and 105 degrees. Similar to the prior discussion, the other terminals, whose disclosure is incorporated herein, lack this configuration of the sharp upwardly angled segment and the sharp downwardly angled segment and the numerous resulting apexes.

As discussed in greater detail below, the third or downwardly sloping extent 188a-188d, and specifically the contact surface 189a-189d, is configured to contact an extent of the female connector assembly 650 when the male terminal assembly 100 is inserted into the female terminal assembly 700. This interaction between these components causes the contact arms 180a-180d to be deflected or displaced inward and towards the center of the male terminal assembly 100 and the spring member 700. This inward deflection of the contact arms 180a-180d causes the spring member 700 to act as a wedge to help ensure that a proper mechanical and electrical connection is created between the contact arms 180a-180d and the female receptacle 702.

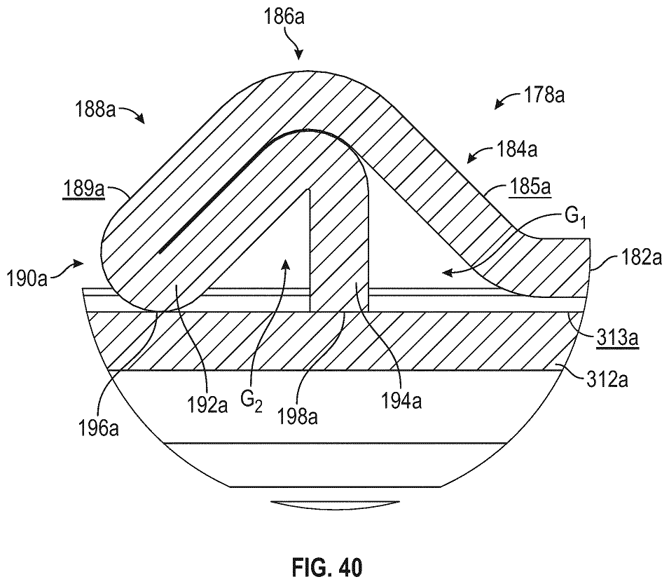

As shown in FIGS. 11 and 13A, the frontal spring contact segment 196a-196d and the intermediate spring contact segment 198a-198d of the contact arms 180a-180d are positioned nearly parallel with an inner surface 181a-181d of the initial or rear extent 182a-182d of the contact arm 180a-180d. Referring to FIGS. 39-40, this configuration provides for (i) a first gap G1 (that is substantially triangular when viewed from the side) to be formed between both the inner surface of the contact arms 180a-180d and the spring member 300 and between the vertical extent 194a and the rear extent 182a of the contact arm 180a, and (ii) a second gap G2 (that is substantially triangular when viewed from the side) to be formed between both the inner surface of the contact arms 180a-180d and the spring member 300 and between the vertical extent 194a and the fourth extent 192a of the contact arm 180a or the frontal spring contact segment 196a-196d. In this manner, the vertical extent 194a engages the outer spring arm surface 313a at a substantially perpendicular angle, preferably at a perpendicular angle. This configuration is beneficial over the configuration shown in FIGS. 3-8 in PCT/US2018/019787 because the assembler of the male terminal assembly 100 does not have to apply a significant force in order to deform a majority of the contact arms 180a-180d outward to accept the spring member 300. This required deformation can best be shown in FIG. 6 of PCT/US2018/019787 based on the configuration of the spring arm 31 and the contact arm 11. The configuration disclosed herein is beneficial because the connector systems 10 performance does not change over time due to material creep. Or stated another way, the connector system 10 does not have a limited shelf life because the spring member 300 is not under constant tension before usage of the system 10.

As shown in FIGS. 8B and 46, at least a portion of the outer edges or shoulder regions 200a, 200b of the contact arms 180a-180d are coined, beveled, or rounded 201a, 201b. Forming the rounded off section 201a, 201b of the outer edges 200a, 200b causes the outer surface of the contact arms 180a-180d, at least the apex 186a-186d, to match the curvature or radii of the inner surface 704 of the female terminal assembly 700. The coined, beveled or rounded section 201a, 201b of the outer edges 200a-200b may: (i) extend along the entire length of the contact arm 180a-180d, (ii) extend along the entire length of the second and third extends 184a-184d, 188a-188d of the contact arms 180a-180d, (iii) extend along a portion (e.g., half of the length) of the second extent 184a-184d of the contact arms 180a-180d and a portion (e.g., half of the length) of the third extent 188a-188d of the contact arms 180a-180d. Without forming the coining, beveling, or rounding section 201a, 201b, the edges 200a, 200b of the contact arms 180a-180d may make contact with the inner surface 704 of the female terminal assembly 700 and could prevent the center of the contact arm 180a-180d from making sufficient contact with said female terminal assembly 700 due to the linear vs. curvilinear configurations of the contact arms 180a-180d and female terminal assembly 700. Preventing the center of the contact arm 180a-180d from making proper contact with said female terminal assembly 700 will likely reduce the current carrying capacity of the system 10. Additionally, omission of the coining, beveling, or rounding section 201a, 201b could leave sharp edges on the contact arms 180a-180d, which may cause the contact arms 180a-180d to score or mark the inner surface 704 of the female terminal assembly 700. Said scoring can lead to a reduction of the number of mating cycles the system 10 can achieve without failure because the scoring can scrape off or damage the internal plating and/or surface 704 of the female terminal assembly 700. In other embodiments, the outer edges or shoulder regions 200a, 200b of the contact arms 180a-180d may not be coined, beveled, or rounded; instead, the contact arms 180a-180d may be bent or material may be deposited on said contact arms 180a-180d to allow the outer surface of said contact arms 180a-180d to substantially match the curvature of the inner surface 704 of the female terminal assembly 700.

As shown in FIGS. 10 and 41, the width of the contact arms 180a-180d may vary from a first width W_{C1} positioned near the base portion 110 of the male terminal body 104 to a second width W_{C2} near the nose 190a-190d of the contact arm 180a-180d. In the embodiment shown in the Figures, the first width W_{C1} is larger than the second width W_{C2} and wherein said first width W_{C1} may be between 0.01% larger to 15% larger than the second width W_{C2}. This reduction in the width along the length of the contact arms 180a-180d: (i) does not reduce the insertion force F_{I} required to move the system 10 from a disconnected state S_{DC} to a connected state S_{CN}, and (ii) may reduce the current carrying capacity of the system 10. In other words, the configuration, function, and performance of the disclosed contact arm 180a-180d is the opposite of the stepped configuration disclosed in PCT/US2021/043788. Nevertheless, in other embodiments, the first width W_{C1} may be equal to the second width W_{C2} (such that the contact arms 180a-180d are not tapped), or the first width W_{C1} may be less than the second width W_{C2} (such that the contact arms 180a-180d have a reverse tapper).

As shown in FIGS. 2-13, the contact arms 180a-180d are not connected to any structure other than extending from the base portion 110. This free-end configuration of the contact arms 180a-180d allows for omnidirectional expansion of said contact arms 180a-180d. Because there is a contact arm opening or void 280a-280d interspersed between each pair of contact arms 180a-180d, there is no supporting wall that surrounds the contact arms 180a-180d. This configuration of the male terminal assembly 100 is substantially different than the configuration disclosed in connection with the male terminal assembly of PCT/US2019/36010. As discussed in PCT/US2019/36010, the removal of the side wall arrangement that surrounds the contact arms 180a-180d could increase the failure rate of the male terminal assembly 100 because the side wall arrangement protects said contact arms 180a-180d. However, this increased failure rate is mitigated because the spring holder 400 has been configured to replace the functionality of the supporting wall. The configuration disclosed herein is beneficial because it replaces expensive copper structures with less expensive non-conductive plastic structures.

The male terminal 101 is typically formed from a single piece of material (e.g., metal); thus, the male terminal 101 is a one-piece male terminal 101 and has integrally formed features. To integrally form these features, the male terminal 101 is typically formed using a die-cutting process. However, it should be understood that other types of forming the male terminal 101 may be utilized, such as casting or using an additive manufacturing process (e.g., 3D printing). In other embodiments, the features of the male terminal 101 may not be formed from a one-piece or be integrally formed, but instead formed from separate pieces that are welded together. In forming the male terminal 101, it should be understood that any number (e.g., between 1 and 100) of contact arms 180a-180d may be formed within the male terminal 101. The male terminal 101, male terminal body 104, the contact arms 180a-180d, or an extent of the contact arms 180a-180d may be plated or coated with a secondary material (e.g., nickel) to help reduce corrosion, reduce insertion forces, or improve conductivity. Additionally, the contact arms 180a-180d or a portion of the contact arms 180a-180d may have rounded or beveled edges.

c. Spring Assembly

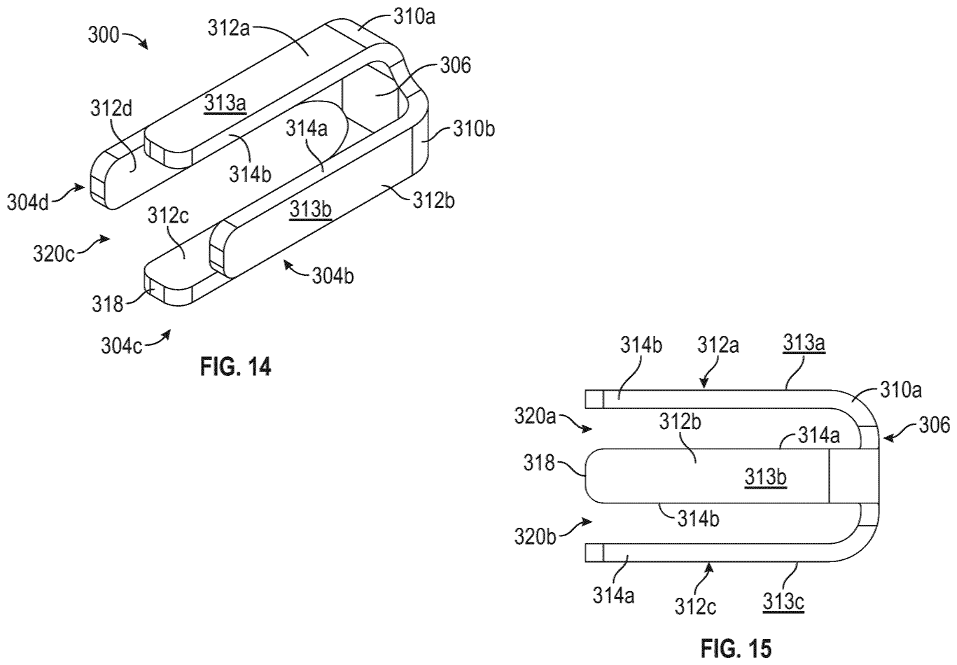

Referring to FIGS. 14-37, the internal spring assembly 298 includes the spring member 300 and the spring holder 400.

Referring to FIGS. 14-15, the spring member 300 includes an arrangement of spring member side walls 304a-304d and a rear spring wall 306. Each spring member side wall 304a-304d is comprised of: (i) a first or curvilinear spring section 310a-310d, and (iii) a second section or spring arm 312a-312d. The curvilinear spring section 310a-310d extends between the rear spring wall 306 and the spring arm 312a-312d and positions the spring arm 312a-312d substantially perpendicular to the rear spring wall 306. In other words, the outer surface 313a-313d of the spring arm 312a-312d is substantially perpendicular to the outer surface of the rear spring wall 306. As shown in FIGS. 14-15, the spring arms 312a-312d extend from the first or curvilinear spring section 310a-310d of the spring member 300, away from the rear spring wall 306, and terminate at a free end 318. The spring arms 312a-312d are not connected to one another and thus spring arm gaps 320a-320d are formed between the spring arms 312a-312d of the spring member 300. The spring arm gaps 320a-320d aid in omnidirectional expansion of the spring arms 312a-312d, which facilitates the mechanical coupling between the male terminal 101 and the female terminal assembly 700.

The spring arms 312a-312d are generally planar and are positioned such that the outer surface 313a-313d of the spring arms 312a-312d is substantially perpendicular to the outer surface of the rear wall 306. Unlike the spring arm 31 that is disclosed within FIGS. 4-8 of PCT/US2018/019787, the free end 318 of the spring arms 312a-312d do not have a curvilinear component. Instead, the spring arms 312a-312d have a substantially planar outer surface 313a-313d. This configuration is beneficial because it ensures that the forces associated with the spring member 300 are applied to the frontal spring contact segment 196a-196d and the intermediate spring contact segment 198a-198d of the contact arms 180a-180d. In contrast, the curvilinear components of the spring arm 31 that are disclosed within FIGS. 4-8 of PCT/US2018/019787 do not apply a force in this manner.

The spring member 300 is typically formed from a single piece of material (e.g., metal); thus, the spring member 300 has a one-piece construction with integrally formed components. In particular, the following features are integrally formed: (i) the curvilinear spring section 310a-310d, and (ii) the spring arm 312a-312d. To integrally form these features, the spring member 300 is typically fabricated using a die forming process. that mechanically forces the spring member 300 into shape. As discussed in greater detail below and in PCT/US2019/036010, when the spring member 300 is formed from a flat sheet of metal, installed within the male terminal 101, and subjected to elevated temperatures, the spring member 300 applies an outwardly directed spring thermal force F_{ST} on the contact arms 180a-180d of the male terminal 101 due in part to the fact that the spring member 300 attempts to return to a flat sheet. However, it should be understood that other methods of forming the spring member 300 may be utilized, such as casting or using an additive manufacturing process (e.g., 3D printing). In other embodiments, the features of the spring member 300 may not be formed from a one-piece or be integrally formed, but instead formed from separate pieces that are welded together.

In an alternative embodiment that is not shown, the spring member 300 may include recesses and associated strengthening ribs. As discussed in PCT/US2019/036010, these changes to the configuration of the spring member 300 alter the forces that are generated by or applied by the spring member 300. In particular, the spring biasing force FSB is the amount of force that is applied by the spring member 300 to resist the inward deflection of the free end 318 of the spring member 300 when the male terminal assembly 100 is inserted within the female terminal assembly 700. Specifically, this inward deflection occurs during the insertion of the male terminal assembly 100 due to the fact that an extent of an outer surface of the male terminal body 104 is slightly larger than the interior of the female receptacle 702. Thus, when the male terminal assembly 100 is inserted into the female terminal assembly 700, the extent of the outer surface is forced towards the center of the male terminal 101. This compression force F_{COM} on the outer surface of the male terminal body 104 displaces the free end 318 of the spring member 300 inward (i.e., towards the center). The spring member 300 resists this inward displacement by providing an outwardly directed spring biasing force F_{SB}. In other embodiments, the spring arms 312a-312d may be coupled to other structures to restrict their omnidirectional expansion. The number and width of individual spring arms 312a-312d and openings may vary. In addition, the width of the individual spring arms 312a-312d is typically equal to one another; however, in other embodiments one of the spring arms 312a-312d may be wider than other spring arms.

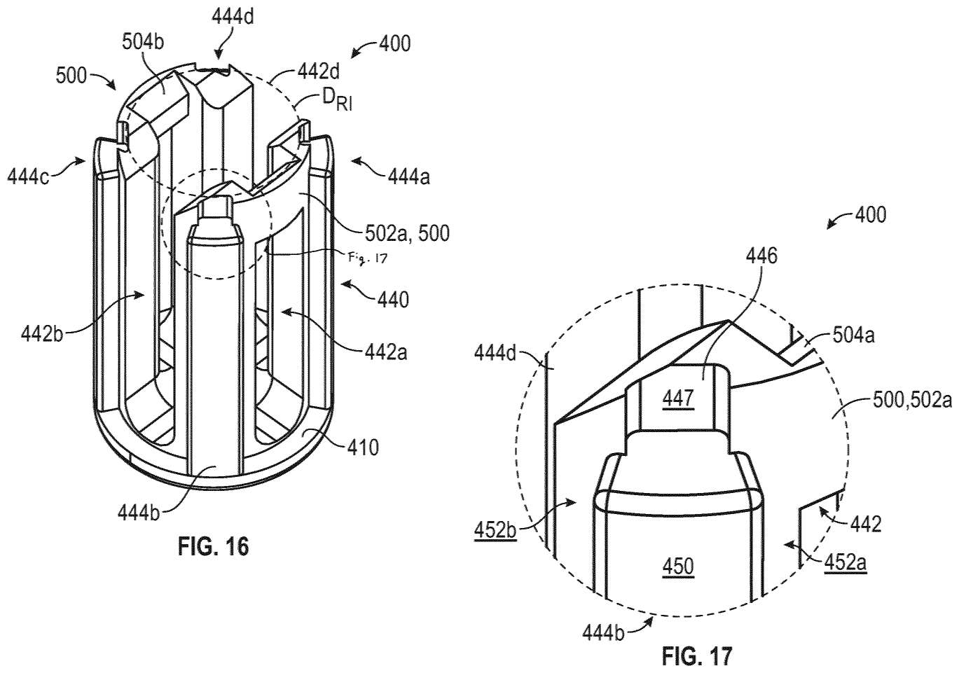

As shown in FIGS. 16-37, the spring holder 400 is an elongated component that is configured to: (i) receive and retain an extent of the spring member 300 in a joined state S_{J}, (ii) secure the spring member 300 and the spring holder 400 within the receptacle 105 of the male terminal body 104 in an assembled state S_{A}, and (iii) help ensure that the spring member 300 is properly positioned, aligned, and/or centered within the male terminal body 104. The spring holder 400 is comprised of a first or head portion 410 and a second or body portion 440. In the joined state S_{J}, the head portion 410 is configured to be positioned forward of or exterior to the nose 190a-190d of the contact arms 180a-180d and has an outer diameter DH that is approximately equal to the outer diameter DOB of base portion 110 of the male terminal body 104. Additionally, it should be understood that the outer diameter DH of the head portion 410 is preferably not substantially larger than the outer diameter DOB of base portion 110 because a larger outer diameter DH may prevent proper mating between the male terminal assembly 100 and the female terminal assembly 700. The head portion 410 also includes a recess 412, which is designed to reduce material weight and cost. It should be understood that in other embodiments, the recess 412 may be omitted or increased.

The second or body portion 440 extends from the head portion 410 and is integrally formed therewith. The body portion 440 includes multiple features (e.g., apertures, members, and structures) that aid in the positioning and retention of the spring member 300 within the male terminal body 104 in the joined state S_{J}. In particular, the body portion 440 includes: (i) structural or positioning ribs 444a-444d that extend from the head portion, (ii) include spring apertures 442a-442d that reside between the ribs 444a-d, and (iii) at least one retaining means 500. As shown in the Figures, the body portion 440 includes two retaining means 500 that are in an opposed positional relationship to each other. Said spring apertures 442a-442d are designed to receive at least an extent of the spring arms 312a-312d and preferably the entire spring arm 312a-312d, when the spring member 300 is positioned within the spring holder 400 in the joined state S_{J}. As such, the spring apertures 442a-442d have a length and a width that is sufficient to receive at least an extent of the spring arms 312a-312d and, preferably the entire spring arms 312a-312d. In other words, the length L_{SA} and width W_{SA} of the spring apertures 442a-442d are slightly larger than the length and width of the spring arms 312a-312d. In this manner, the spring arms 312a-312d and the spring apertures 442a-442d are cooperatively dimensioned to allow these two structures to intermesh in the joined state S_{J}.

Unlike the spring holder disclosed in PCT/US2021/043788, the spring apertures 442a-442d of the spring holder 400 disclosed herein does not include two portions with different widths. Instead, the spring apertures 442a-442d of the spring holder 400 have a constant or uniform width along the entirety of the holder 400, namely because the width of the contact arms 180a-180d disclosed above do not substantially change along their lengths. Using a spring holder that has spring apertures with constant or uniform widths would not be desirable in connection with the connector system disclosed in PCT/US2021/043788 because: (i) either the head of the contact arm would undesirably interact with the spring holder during insertion and/or use of the system, or (ii) the spring member could undesirably pivot or rotate within the spring holder. It should be understood that in other embodiments, the width of the spring apertures 442a-442d may change to account for changes in the width of the contact arms.

The positioning ribs 444a-444d are designed to align and position the spring member 300 within the male terminal body 104. The positioning ribs 444a-444d extend along at least an extent of the spring arms 312a-312d and preferably the entire length of the spring arms 312a-312d. Due in part to the formation of the spring apertures 442a-442d within the positioning ribs 444a-444d, the positioning ribs 444a-444d have an arrow-shaped cross-section, wherein the outermost extent of the arrow shape is curvilinear, as best shown in FIG. 19. In other words, the positioning ribs 444a-444d have: (i) an outer curvilinear surface 450, (ii) opposed L-shaped surfaces 452a, 452b that extend inward from the curvilinear surface, and (iii) two inner surfaces 454a, 454b that extend from an extent of the opposed L-shaped surface towards an apex 456 and are configured to be positioned adjacent to the outer edges 314a-314b of the spring arms 312a-312d. Referring to FIGS. 36 and 37, the width W_{CS} of the curvilinear surface 450 is substantially equal to the width W_{PP} positioning projections 160, which ensures that there is a substantial distance or width W_{C1} between the outer edges 200a, 200b of the contact arms 180a-180d and the inner surfaces 454a, 454b that extend from the curvilinear surface 450, whereby this substantial distance or width W_{C1} helps to ensure that the contact arms 180a-180d do not contact the spring holder 400. In this embodiment, the distance or width W_{C1} is between 0.4 mm and 0.7 mm. However, it should be understood that in other embodiments, the distance or width W_{C1} may be reduced to a distance that is between 0.05 mm and 0.15 mm. Reducing the distance or width W_{C1} will increase the width W_{CS} of the curvilinear surface 450 and reduce or eliminate the opposed L-shaped surface 454a, 454b, which in turn may increase the robustness of the male terminal assembly 100 because the contact arms 180a-180d more securely protected. Nevertheless, reducing the distance or width W_{C1} too far may degrade the performance of the system 10.

Unlike the spring holder that is disclosed in PCT/US2021/043788, a recess 446 is formed in an extent of the positioning ribs 444a-444d and is positioned: (i) near the lateral beams 502a-502b of the retaining means 500, and (ii) adjacent to the free end of the projection that is formed from a combination of the outer curvilinear surface 450 and the opposed L-shaped surfaces 452a, 452b. The recess 446 is configured to create a gap 448 between the inner surface 131 of the base portion 110 and the inner surface 447 of the recess 446 in order to account for mating tolerances when assembling the connector system 10.

The retaining means 500 is designed and configured to retain the spring member 300 within the holder 400. In the embodiment shown in the Figures, said retaining means 500 are lateral beams 502a-502b that extend between the positioning ribs 444a-444d. In particular, lateral beam 502a is positioned near the rear end 400b of the holder 400 and extends between positioning ribs 444a, 444d and lateral beam 502b is positioned near the rear end 400b of the holder 400 and extends between positioning ribs 444b, 444c. The outer surface of the lateral beams 502a, 502b is rounded to substantially match the curvature of the inner surface 131 of the base portion 110 of the male terminal 101. The inner rearmost surface of the lateral beams 502a-502b is sloped to aid in coupling the holder 400 and spring member 300. Specifically, these sloped walls 504a-504b help center the spring member 300 and force the first pair of positioning ribs 444a-444b away from the second pair of positioning ribs 444c-444d. As such, the user or assembler must simply apply a force on the spring member 300 directed to the head portion 410 to elastically deform the positioning ribs 444a-444d, thus allowing spring member 300 to reach a seated position. Once the spring member 300 is positioned in the retainer 400, the positioning ribs 444a-444d elastically return to a normal or non-deformed position. In this non-deformed position, the lateral beams 502a-502b are positioned rearward of the spring member 300 to retain the spring member 300 within the holder 400. It should be understood that uncoupling the spring member 300 from the holder 400 requires the user or installer to apply forces in opposite directions (i.e., away from the head potion 410) in order to deform the pairs of positioning ribs 444a-444d further enough to allow for the extraction of the spring member 300 from the holder 400. It should be understood that lateral beams are not coupled across each of the positioning ribs 444a-444d (e.g., between 444b and 444c) because deforming the positioning ribs 444a-444d in this alternative configuration to a necessary extent may be difficult, if not impossible.

It should be understood that in other embodiments, the retaining means 500 may take other forms, such as: (i) a locking rear wall, (ii) at least one projection that extends from the spring member 300 and that is received by the holder 400, (iii) an opening in the spring member 300 that receives an extent of the holder 400, or (iv) any other way of retaining/coupling one structure to another structure, which may include the use of projections, tabs, grooves, recesses, or extents. It should further be understood that the retaining means 500 may be force-based, wherein such forces that may be utilized are magnetic forces or bonding, such as weldment. In contrast to a mechanical or force-based retaining means 500, the retaining means 500 may be a method or process of forming the male terminal assembly 100. For example, the retaining means 500 may not be a structure, but instead may be simultaneous printing of the spring member 300 within the holder 400 in a way that does not require assembly. In other words, the retaining means 500 may take many forms (e.g., mechanical based, force based, or process based) to achieve the purpose of properly securing the spring member 300 to the holder 400.

Referring to FIGS. 16-19, the interior portion 440 of the spring holder 400 includes a number of integrated structures that form three separate diameters. The first diameter D_{OI} is the outer diameter of the interior portion 440, which is configured to be substantially equal to both of the outer diameter DOB of base portion 110 and the outer diameter DH of the head portion 410 of the holder 400. This configuration is beneficial because the spring holder 400 can help protect the contact arms 180a-180d from accidental damage and can reduce the amount of copper contained in the terminal 101. It should be understood that the outer diameter D_{OI} of the interior portion 440 is preferably not substantially larger than the outer diameter DOB of base portion 110 because a larger diameter may prevent proper mating between the male terminal assembly 100 and the female terminal assembly 700. The second diameter Du is the inner diameter of the interior portion 440, which is configured to be substantially equal to the outer diameter Dos of the spring member 300 (formed by the outer edges of the spring member 300). This smaller inner diameter D_{II} of the interior portion 440 enables insertion of the holder 400 within the male terminal body 104 and specifically within the base portion 110 of the male terminal body 104. Finally, the third diameter D_{RI} is the recessed diameter of the interior portion 440, which is configured to create a gap 448 between the inner surface 131 of the base portion 110 and the inner surface of the recess 446 in order to account for mating tolerances when assembling the connector system 10. It should be understood that the third diameter D_{RI} may be omitted and other diameters and configurations of the holder 400 are contemplated by this disclosure.

d. Disjoined State to the Assembled State

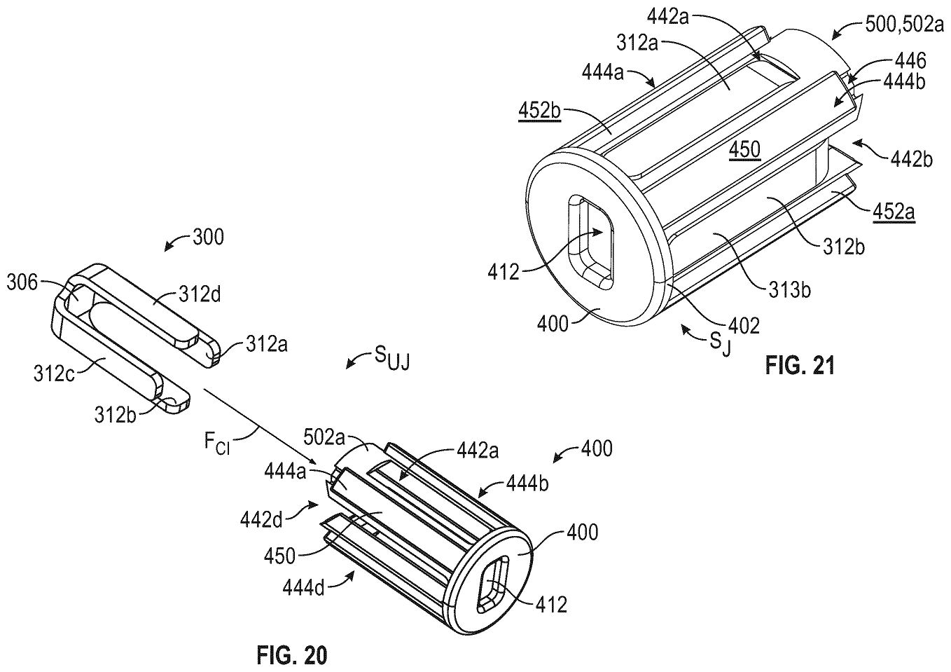

Positioning the spring assembly 298, including the spring member 300 and the spring holder 400, within the male terminal body 104 occurs across multiple steps or stages to arrive at an assembled state S_{A}. The first step in this process is shown in FIG. 20 which shows the first embodiment of the spring assembly 298 in an disjoined state S_{DJ}, while FIGS. 21-29 shows the first embodiment of the spring assembly in a joined state S_{J}. As described above, to move the spring assembly 298 from the disjoined state S_{DJ} to the joined state S_{J}, the user or assembler aligns the spring member 300—namely, the spring arm 312a-312d—with the spring arm apertures 442a-442d of the spring holder 400. After these components are properly aligned, the user applies a first coupling force F_{C1} on these components in order to temporally elastically deform the positioning ribs 444a-444d in order to allow the spring member 300 to overcome the retaining means 500. Once the spring member 300 is positioned within the holder 400, the positioning ribs 444a-444d will return to their original state, whereby the ribs 444a-d and the spring arms 312a-d are intermeshed and the spring member 300 resides within the holder 400 via the retaining means 500.

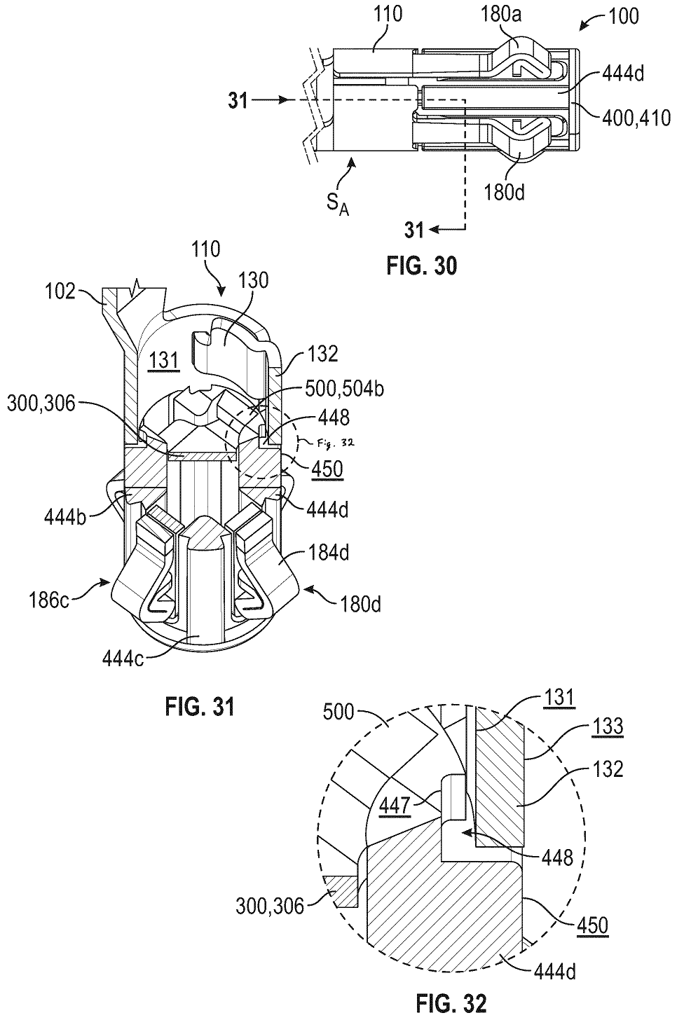

The joined S_{J} spring assembly 298 is then inserted within the male terminal body 104 which is accomplished by positing the body portion 440 within the spring assembly receptacle 105 of the male terminal body 104 and applying a second coupling force F_{C2} that presses both of these components into one another. While the user or assembler is applying this coupling force F_{C2}, the user or assembler should align the outer curvilinear surface 450 of the positioning ribs 444a-444d with the positioning projections 160. To align these structures, the assembler may have to slightly twist the spring assembly 298 a few degrees (i.e., less than 15 degrees, preferably less than 10 degrees) prior to inserting it into the male terminal body 104. Once the rear extent of the positioning ribs 444a-444d is positioned adjacent to the outer surface of the positioning projections 160, the male terminal assembly 100 reaches an assembled state S_{A}, which is shown in FIGS. 30-42.

### 2) Female Connector Assembly

Referring to FIGS. 43-48, the female connector assembly 650 is comprised of: (i) the female housing 670 and (ii) the female terminal assembly 700.

a. Female Housing

The female housing 670 is designed to: (i) receive the female terminal assembly 700, (ii) facilitate the coupling of the male terminal assembly 100 with the female terminal assembly 700, (iii) minimize the chance that a foreign object accidentally makes contact with the female terminal assembly 700, and (iv) ensure that the connector system 10 meets industry standards, such as USCAR specifications. The female housing 670 includes a sidewall 672 having a configuration that substantially matches the configuration of the female terminal assembly 700. In the embodiment shown in the figures, the female terminal assembly 700 has a cylindrical configuration. Thus, the sidewall 672 has an interior configuration that substantially matches the cylindrical configuration of the female terminal assembly 700.

The sidewall 672 of the female housing 670 extends past the upper most surface of the female terminal assembly 700 to allow for the formation of a male compression means 674 in an extent of the sidewall 672. As shown in the Figures, namely FIG. 48, the male compression means 674 is a sloped or ramped surface 676 that extends from an outermost edge 673 of the sidewall 672 to the upper most edge 700a of the female terminal assembly 700. In the disclosed embodiment, the sloped or ramped surface 676 extends from each of the outermost edge 673 and has a substantially linear configuration. However, it should be understood that the sloped or ramped surface 676 may only extend from a portion of the outermost edge 673. The male compression means 674, and the sloped or ramped surface 676 shown in the Figures, is designed to compress the contact arms 180a-180d as the male terminal assembly 100 moves from being separated from the female terminal assembly 700 in a disconnected state S_{DC} to being positioned within an extent of the female terminal assembly 700 in a connected state S_{CN} (see FIGS. 1 and 45-48). As such, the distance between opposed points on the outermost edge 673 is equal to a sidewall distance, wherein the sidewall distance D_{S} is greater than the rearmost edge distance DRE that extends between opposed points on the rearmost edge 678 of the sloped or ramped surface 676. And wherein the rearmost edge distance DRE is greater than or equal to a receiver distance DR that extends between opposed points on the inner surface 704 of the receptacle 702 of the female terminal assembly 700. In particular, the sidewall distance D_{S} is between 0.1% and 15% larger than the receiver distance DR, and where the rearmost edge distance DRE is equal to or greater 0.1% and 3% larger than the receiver distance DR. In other words, the sloped or ramped surface 676 is angled relative to the outer surface of the sidewall 672 and/or the inner surface 704 of the receptacle 702 of the female terminal assembly 700. In particular, the interior angle delta δ that extends between the inner surface of the sloped or ramped surface 676 and the outer surface of the sidewall 672 is between 0.1 degrees and 10 degrees.

This sloped or ramped surface 676 is made from a polymer or plastic material and as a result, has a coefficient of friction that is lower than a coefficient of friction associated with a metal surface. In other words, a first friction value is formed when the extent (e.g., a contact arm 180a-180d) of the male terminal assembly 100 engages with a male terminal compression means 674 formed from a non-metallic material (e.g., plastic). In an alternative embodiment, a second friction value would be formed if the extent (e.g., a contact arm 180a-180d) of the male terminal assembly 100 was to engage with a male terminal compression means formed from a metallic material (e.g., copper). Comparing the friction value from the disclosed embodiment to the friction value from the alternative embodiment, it should be understood that the first friction value is less than the second friction value. The lower coefficient of friction reduces the insertion force that is required to insert the male terminal assembly 100 into the female terminal assembly 700. This is beneficial because: (i) industry specifications, including USCAR 25, has requirements that the insertion force F_{I} cannot be greater than 45 Newtons for a class 2 connector and 75 Newtons for a class 3 connector and (ii) the use of a greater spring biasing force F_{SB}, which thereby increases the insertion force F_{I}, is desirable to help ensure that the contact arms of the male terminal assembly remain in contact with the inner surface 704 of the receptacle 702 of the female terminal assembly 700. Further, this lower coefficient of friction is beneficial because the connector system 10 can move from the disconnected state S_{DC} to a connected state S_{CN} while meeting class 2/class 3 USCAR specifications without requiring a lever assist to mechanically supplement the connection process. Eliminating the lever assist reduces the size, weight, and cost of manufacturing the connector system 10. It should be understood that to further reduce the coefficient of friction, the sloped or ramped surface 676 may be coated with a substance that reduces this coefficient or the sloped or ramped surface 676 may be made from a material that has an even lower coefficient of friction.

Due to the configuration of the male and female connectors 50, 650, different levels of force are required as the connector system 10 moves from the disconnected state S_{DC} to the connected state S_{CN}. For example, a first insertion force Fu is required to move the male terminal assembly 100 when an extent (e.g., a contact arm 180a-180d) of the male terminal assembly 100 is in sliding engagement with the male terminal compression means 674 and a second insertion force F_{I2} is required to move the male terminal assembly 100 when the extent (e.g., a contact arm 180a-180d) male terminal assembly 100 is positioned in the female terminal receiver 702. Comparing the forces, it should be understood that the second insertion force F_{I2} is less than the first insertion force Fn. This is beneficial because it provides the user with a tactile feedback to inform the user that the male terminal assembly 100 is properly seated within the female terminal assembly 700. In fact, this tactile feedback fells to the user like the male terminal assembly 100 is being pulled into the female terminal assembly 700.

To minimize the chance that a foreign object accidentally makes contact with the female terminal assembly 700, the housing 2100 may include an optional touch proof element, such as a post. As disclosed within PCT/US2019/036070, the touch proof post is configured to fit within a touch proof post recess or opening formed in the spring holder 400. The shape of the touch proof post recess or opening is configured to substantially mirror the shape of the touch proof post. The mirroring of these shapes helps ensure proper insertion of the touch proof post with the touch proof probe opening and may provide a reduction in the vibration between the male connector assembly 50 and the female terminal assembly 700. This reduction in the vibration between these components may help reduce failures of the connector system 10. It should be understood that the touch proof post and its associated opening may be omitted or may have another configuration (e.g., as disclosed in U.S. Provisional Application No. 63/222,859, which is incorporated herein by reference). To minimize the chance that the male connector assembly 50 can be accidently disconnected from the female connector assembly 650, the female connector assembly 650 may include an optional non-deformable female CPA structure that is designed and configured to interact with the male CPA structures, when the connector assemblies 50, 650 are coupled to one another. Said non-deformable female CPA structure is integrally formed with the sidewall 672 of the housing 670. Additional details about the structure and/or function of the female CPA structure are disclosed in PCTUS2019/036070, PCTUS2020/049870, PCTUS2021/033446, all of which are incorporated herein by reference.

b. Female Terminal

The female terminal assembly 700 of the female connector assembly 650 is comprised of: (i) a female terminal connection member 701, and (ii) the female terminal body 710. Specifically, the female terminal connection member 701 is coupled to the female terminal body 710. In this embodiment, the female terminal connection member 701 is a wire receiver, wherein said wire receiver has a blade shaped structure that is configured to receive an extent of a structure (e.g., lead or wire) that connects the female terminal assembly 700 to a device (e.g., an alternator) outside of the connector system 10. A wire is typically welded to the wire receiver; however, other methods (e.g., forming the wire as a part of the wire receiver) of connecting the wire to the wire receiver are contemplated by this disclosure. In other embodiments, the female terminal connection member 701 may be a crimping connection, a circuit board connector, have a U-shaped configuration, or any other type of connection member 102 that mechanically and electrically couples the female terminal body 710 to an external device, part, or extent.

The female terminal body 710 of the female connector assembly 650 includes a sidewall 712 having an inner surface 704 that forms cylindrical terminal receptacle 702 with a receiver distance DR that extends between opposed points on the inner surface 704 of the sidewall 712. As discussed above, the receiver distance DR is: (i) less than the sidewall distance D_{S} and (ii) equal to or greater than the rearmost edge distance DRE. Additionally, the receiver distance is between 0.1% and 15% smaller than a male terminal assembly distance that extends between the outermost extents of opposed contact arms 180a-180d. Forming a terminal receptacle 702 with a receiver distance that is less than the male terminal assembly distance ensures that the contact arms 180a-180d are compressed when the male terminal assembly 100 is inserted into the female terminal assembly 700. This compression of the male terminal assembly 100 compresses the spring member 300. As such, the spring member 300 exerts an outwardly directed biasing force F_{SB} on the contact arms 180a-180d to help ensure that they remain in contact with the inner surface 704 of the terminal receptacle 702 to facilitate the electrical and mechanical coupling of the male terminal assembly 100 with the female terminal assembly 700.

The female terminal assembly 700 is typically formed from metal and preferably a highly conductive metal, such as copper. The female terminal assembly 700 may be plated or clad with Ni—Ag. In other embodiments, the sidewall 712 may be made from a different material, and/or the female terminal assembly 700 may not be plated or clad with Ni—Ag. Once the female terminal assembly 700 is fabricated, it can be coupled to the wire, part, component, or device via the female terminal connection member 701.

### 3) Connecting the Connector System

The connector system 10 can move from a disconnected state S_{DC} to a partially connected state, where the contact arms 180a-180d of the male connector assembly 50 in contact with the ramped or sloped surface 676 of the female connector assembly 650. This ramped or sloped surface 676 gently and smoothly compresses the contact arms 180a-180d until they can easily slide into and make contact with the inner surface 704 of the female receptacle 702. This process is described in greater detail within PCT/US2019/36070 and is incorporated herein. Once the male connector assembly 50 is connected to the female connector assembly 650, the connector system 10 has moved from the partially connected state to the connected state S_{CN}. Finally, a force is applied to the CPA that causes it to interact with an extent of the external component. Once this occurs, the male connector assembly 50 is locked to the female connector assembly 650. Finally, the installer can scan an extent of the CPA that is visible through the opening within the housing, as described within PCT/US2020/049870.

### 4) Terminal Properties and Functionality

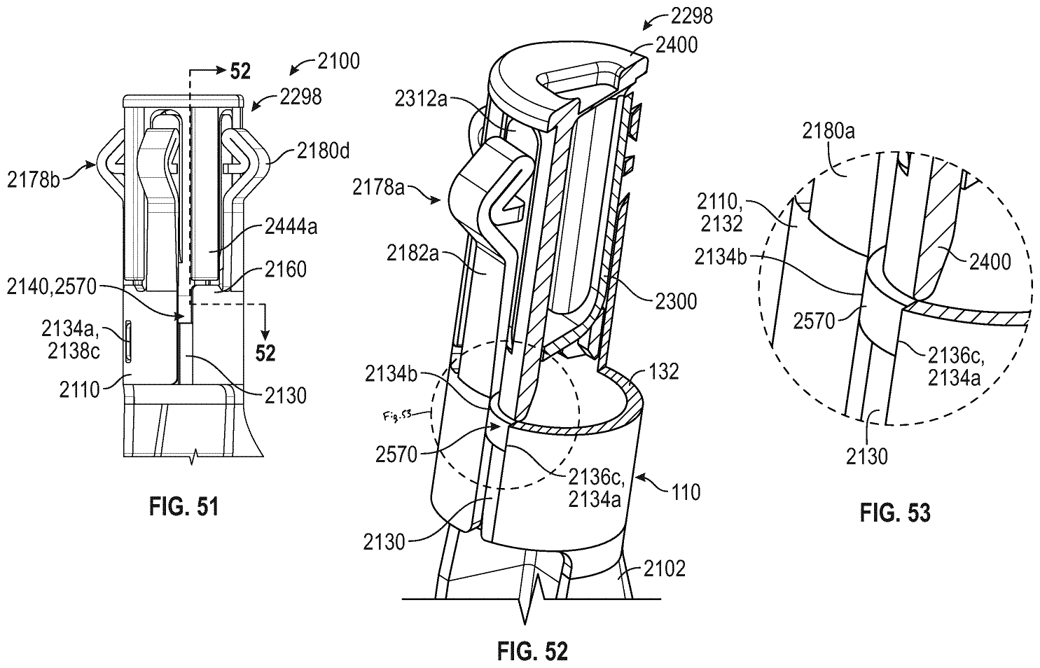

FIG. 51 depicts a cross-section of the male connector assembly 50 coupled to the female connector assembly 650 in the connected state S_{CN}. While the below disclosure is discussed in connection with the first embodiment of the system 10, it should be understood that this disclosure applies in equal force to all embodiments of the system 1010, 2010, 3010, 4010, 5010. As best shown in FIG. 51, one or more outer surfaces of the spring arms 312a-312d contact the frontal spring contact and the intermediate spring contact segments 196a-196d, 198a-198d of the respective contact arms 180a-180d. As discussed above, the outermost extent or diameter of the contact arms 180a-180d are slightly larger than the inner diameter of the female terminal body 710. As such, when these components are mated with one another, the spring member 300 is compressed. This compression of the spring member 300 creates a wedging effect or outwardly directed biasing force F_{SB} against the contact arms 180a-180d and away from the interior of the spring member 300.

The male terminal body 104, including the contact arms 180a-180d, may be formed from a first material such as copper, a highly-conductive copper alloy (e.g., C151 or C110), aluminum and/or another suitable electrically conductive material. The first material preferably has an electrical conductivity of more than 80% of IACS (International Annealed Copper Standard, i.e., the empirically derived standard value for the electrical conductivity of commercially available copper). For example, C151 typically has 95% of the conductivity of standard, pure copper compliant with IACS. Likewise, C110 has a conductivity of 101% of IACS. In certain operating environments or technical applications, it may be preferable to select C151 because it has anti-corrosive properties desirable for high-stress and/or harsh weather applications. The first material for the male terminal body 104 is C151 and is reported, per ASTM B747 standard, to have a modulus of elasticity (Young's modulus) of approximately 115-125 gigapascals (GPa) at room temperature and a coefficient of terminal expansion (CTE) of 17.6 ppm/degree Celsius (from 20-300 degrees Celsius) and 17.0 ppm/degree Celsius (from 20-200 degrees Celsius).

The spring member 300 may be formed from a second material such as spring steel, stainless steel (e.g., 301SS, ¼ hard), and/or another suitable material having greater stiffness (e.g., as measured by Young's modulus) and resilience than the first material of the male terminal body 104. The second material preferably has an electrical conductivity that is less than the electrical conductivity of the first material. The second material also has a Young's modulus that may be approximately 193 GPa at room temperature and a coefficient of terminal expansion (CTE) of 17.8 ppm/degree Celsius (from 0-315 degrees Celsius) and 16.9 ppm/degree Celsius (from 0-100 degrees Celsius). In contemplated high-voltage applications, the cross-sectional area of copper alloy forming the first connector is balanced with the conductivity of the selected copper alloy. For example, when a copper alloy having lower conductivity is selected, the contact arms 180a-180d formed therefrom have a greater cross-sectional area so as to adequately conduct electricity. Likewise, selection of a first material having a higher conductivity may allow for contact arms 180a-180d having a relatively smaller cross-sectional area while still meeting conductivity specifications.

In an example embodiment, the CTE of the second material may be greater than the CTE of the first material, i.e., the CTE of the spring member 300 is greater than the CTE of the male terminal body 104. Therefore, when the assembly of the male terminal body 104 and the spring member 300 is subjected to the high-voltage and high-temperature environment typical for use of the electrical connector described in the present disclosure, the spring member 300 expands relatively more than the male terminal body 104. Accordingly, the outward force F_{SB} produced by the spring member 300 on the contact arms 180a-180d of the male terminal body 104 is increased in accordance with the increased temperature, which is reference to below as a thermal spring force F_{ST}.

An example application of the present disclosure, such as for use in a charge coupler, is suitable for deployment in a class 5 automotive environment, such as that found in passenger and commercial vehicles. Class 5 environments are often found under the hood of a vehicle, e.g., alternator, and present 150° Celsius ambient temperatures and routinely reach 200° Celsius. When copper and/or highly conductive copper alloys are subjected to temperatures above approximately 150° Celsius said alloys become malleable and lose mechanical resilience, i.e., the copper material softens. However, the steel forming the spring member 300 retains hardness and mechanical properties when subjected to similar conditions. Therefore, when the male terminal body 104 and spring member 300 are both subjected to high-temperature, the first material of the male terminal body 104 softens and the structural integrity of the spring member 300, formed from the second material, is retained, such that the force applied to the softened contact arms 180a-180d by the spring member 300 more effectively displaces the softened contact arms 180a-180d outward relative the interior of the male terminal body 104, in the fully connected position SFC.

The male terminal body 104, spring member 300, and female terminal body 710, are configured to maintain conductive and mechanical engagement while withstanding elevated temperatures and thermal cycling. Further, the male terminal body 104 and female terminal body 710 may undergo thermal expansion as a result of the elevated temperatures and thermal cycling, which increases the outwardly directed force F_{SB} applied by the male terminal body 104 on the female terminal body 710. The configuration of the male terminal body 104, spring member 300, and the female terminal body 710 increase the outwardly directed connective force there between while the connector system 10 withstands thermal expansion resulting from thermal cycling in the connected position Pc.

Based on the above exemplary embodiment, the Young's modulus and the CTE of the spring member 300 is greater than the Young's modulus and the CTE of the male terminal body 104. Thus, when the male terminal body 104 is used in a high power application that subjects the connector system 10 to repeated thermal cycling with elevated temperatures (e.g., approximately 150° Celsius) then: (i) the male terminal body 104 become malleable and loses some mechanical resilience, i.e., the copper material in the male terminal body 104 softens and (ii) the spring member 300 does not become as malleable or loses as much mechanical stiffness in comparison to the male terminal body 104.

Thus, when utilizing a spring member 300 that is mechanically cold forced or formed into shape (e.g., utilizing a die forming process) and the spring member 300 is subjected to elevated temperatures, the spring member 300 will attempt to return to its uncompressed position, which occurs prior to insertion of the male terminal assembly 100 within the female terminal assembly 700, and preferably to its original flat state, which occurs prior to the formation of the spring member 300. In doing so, the spring member 300 will apply a generally outward directed thermal spring force F_{ST}, (as depicted by the arrows labeled “F_{ST}” in FIG. 51) on the frontal spring contact and the intermediate spring contact segments 196a-196d, 198a-198d of the contact arms 180a-180d. This thermal spring force F_{ST}, is dependent upon local temperature conditions, including high and/or low temperatures, in the environment where the system 10 is installed. Accordingly, the combination of the spring biasing force F_{SB}, and the thermal spring force F_{ST}, provides a resultant outwardly directed biasing force F_{RSB}, that ensures that the outer or contact surface 189a-189d of the contact arms 180a-180d are forced into contact with the inner surface 704 of the female terminal body 710 when the female terminal assembly 700 is inserted into the female terminal 700 and during operation of the system 10 to ensure an electrical and mechanical connection between these components. Additionally, with repeated thermal cycling events, the male terminal assembly 100 will maintain and/or increase in the outwardly directed resultant spring forces, S_{RBF}, that are applied to the female terminal assembly 700 during repeated operation of the system 10.

Further illustrated in FIG. 51, in the connected state S_{CN}, the male terminal assembly 100 provides 360° compliance with the female terminal assembly 700 to ensure that a sufficient amount of outwardly directed biasing force F_{SB} is applied by the male terminal assembly 100 to the female terminal assembly 700 for electrical and mechanical connectivity in all four primarily directions. This attribute allows for omission of a keying feature and/or another feature designed to ensure a desired orientation of the components during connection. The 360° compliance attribute of the system 10 also aids in maintaining mechanical and electrical connection under strenuous mechanical conditions, e.g., vibration. In a traditional blade or fork-shaped connector with 180° compliance, i.e., connection on only two opposing sides, vibration may develop a harmonic resonance that causes the 180° compliant connector to oscillate with greater amplitude at specific frequencies. For example, subjecting a fork-shaped connector to harmonic resonance may cause the fork-shaped connector to open. Opening of the fork-shaped connector during electrical conduction is undesirable because momentary mechanical separation of the fork-shaped connector from an associated terminal may result in electrical arcing. Arcing may have significant negative effects on the 180° compliant terminal as well as the entire electrical system of which the 180° compliant terminal is a component. However, the 360° compliance feature of the present disclosure may prevent the possible catastrophic failures caused by strong vibration and electrical arcing.

a. Terminal Sizes

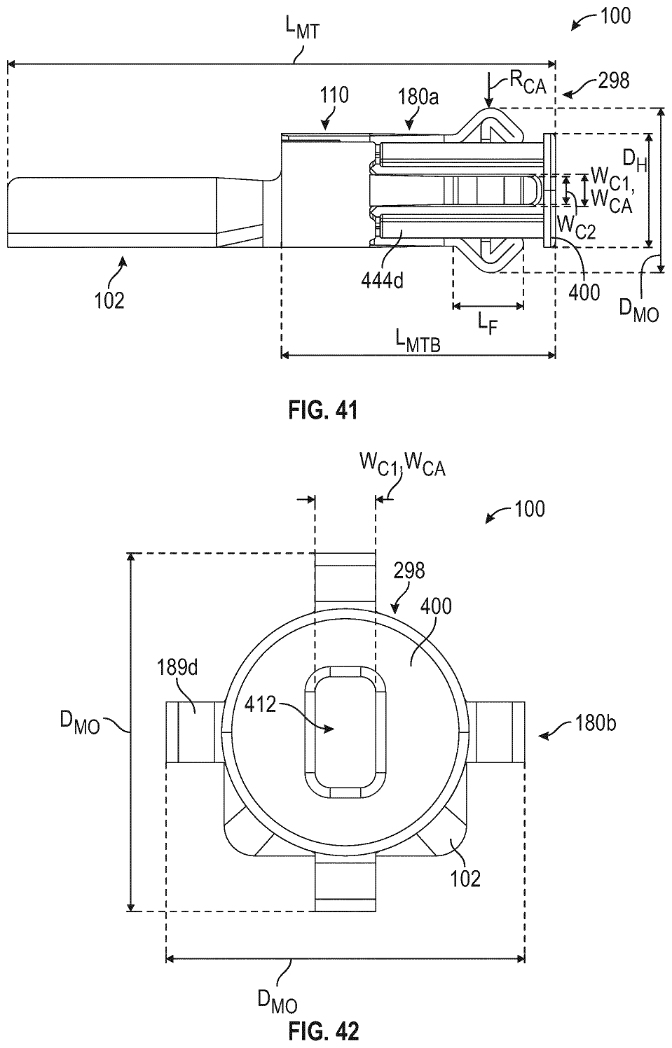

FIGS. 41 and 42 show various measurements of the male terminal assembly 100. In particular, first width W_{C1} of the contact arms is between to 0.6 mm and 2.4 mm, second width or contact arm width W_{CA} is between 0.7 mm and 2.8 mm, diameter DH of the head portion 410 is between 2.45 mm and 9.8 mm, outer distance D_{MO} between opposed exterior apexes 186a, 186c of the contact arms 180a, 180c is between 4 mm and 16 mm, the length L_{F} of the folded portion 178a-178d of the contact arms is between 1.5 mm and 6 mm, the length L_{MTB} of the male terminal body 104 is between 6 mm and 23.5 mm, the length L_{MT} is between 11 mm and 47 mm, radius RCA of the contact arm is between 0.4 mm and 1.5 mm.

### 5) Alternate Embodiments of the Male Connector Assembly

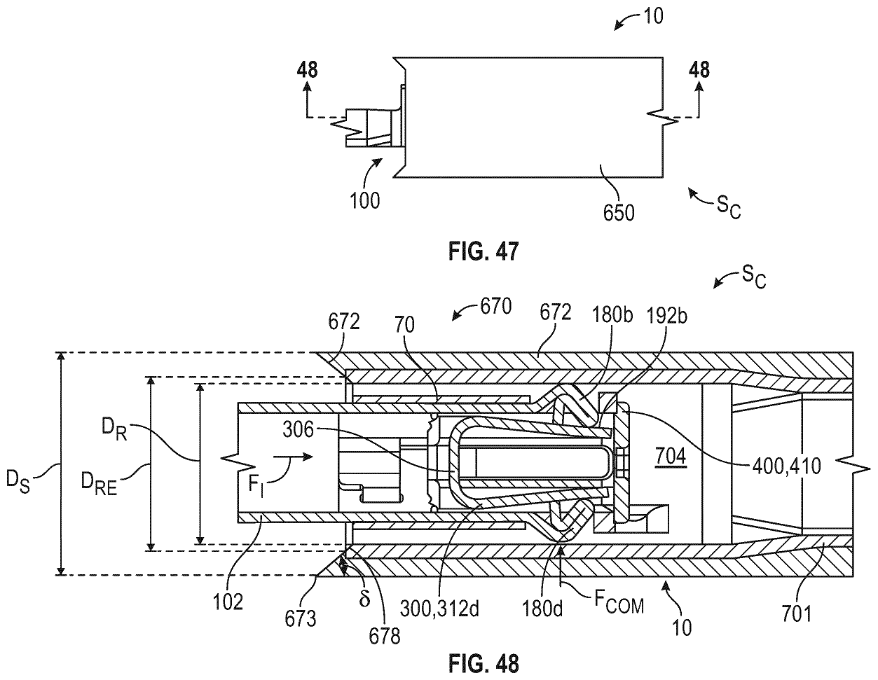

FIGS. 47-48 show a second embodiment of the spring assembly 1298 that may be used instead of the spring assembly 298 shown and described above. Because a substantial majority of the structures contacted in this embodiment 1298 are similar to the first embodiment 298, it should be understood that reference numbers that are shown in the figures may be omitted from the specification for sake of brevity as like structures have like numbers. For example, the disclosure in connection with retaining means 500 is not repeated herein, but it applies to retaining means 1500, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. Unlike the first embodiment of the spring assembly 298 and other embodiments of spring holders that are disclosed in applications that are incorporated herein, the second embodiment 1298 includes an over-travel or over-compression protection projection 1550. Said over-travel protection projection 1550 extends inward from the head portion 1410 of the spring holder 1400 and is configured to be positioned between the spring arms 1312a-1312d. The over-travel protection projection 1550 can have a cross-sectional shape of a circle, square, cross, or another other similar shape that will help prevent the spring member 1300 from being over compressed due to an external force FE on the contact arms 1180a-1180d. This is desirable to increase the durability of the system 1010 because said over-travel protection projection 1550 will only allow the contact arms 1180a-1180d and spring arms 1312a-1312d to deform a distance DD do to the contact between the inner surface of the spring arms 1312a-1312d and the outer surface of the over-travel protection projection 1550. This design in desirable in order to help prevent the contact arms 1180a-1180d and spring arms 1312a-1312d from being deformed to a point that said structures cannot return to an original or near original state; thus, causing the system 1010 to suffer a critical failure.

FIGS. 51-53 show a third embodiment of the male terminal assembly 2100 that includes a spring assembly 2298 that may be used instead of the spring assembly 298 or 1298 shown and described above. Because a substantial majority of the structures contacted in this embodiment 2298 are similar to the first embodiment 298 or second embodiment 1298, it should be understood that reference numbers that are shown in the figures may be omitted from the specification for sake of brevity as like structures have like numbers. For example, the disclosure in connection with retaining means 500 is not repeated herein, but it applies to retaining means 2500, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. Unlike the first embodiment of the spring assembly 298 or the second embodiment of the spring member 1298, the third embodiment 2298 includes an alignment mechanism or a poka-yoke 2570. Said alignment mechanism or a poka-yoke 2570 is designed to fit within the gap 2140 formed between multi-segmented first end 2134a (e.g., forward extent 2136b) and the second end 2134b. This alignment mechanism 2570 is designed to help ensure that the position structures 2444a-2444d are aligned with the positioning projections 2160. The alignment of the position structures 2444a-2444d and the positioning projections 2160 is necessary to avoid undesirable contact with the contact arms 2180a-2180d or misalignment between the spring member 300 and the contact arms 2180a-2180d.

### Fourth Embodiment of the Connector System

FIGS. 63-76 show a fourth embodiment of a connector system 3010. Because a substantial majority of the structures contacted in this embodiment 3010 are similar to the first embodiment 10, it should be understood that reference numbers that are shown in the figures may be omitted from the specification for sake of brevity as like structures have like numbers. For example, the disclosure in connection with female terminal assembly 700 is not repeated herein, but it applies to female terminal assembly 3700, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference.

Unlike the first three embodiments of the system 10, 1010, and 2010, the fourth embodiment 3010 omits the spring assembly 298, 1298, and 2298. In other words, the male terminal assembly 3100 lacks a separate spring member and a spring holder. Due to the omission of these components, the male terminal body 3104 includes: (i) sidewall portions 3202a-3202d that extend along a substantial length of the contact arms 3180a-3180d, (ii) an end extent 3204 which is coupled to the sidewall portions 3202a-3202d and extends around the diameter of the male terminal body 3104, (iii) an internal spring member 3350 that is integrally formed as part of the male terminal body 3104. Additionally, while the fourth embodiment 3010 includes an interlocking member 3130, said interlocking member 3130 has been moved from the base 3110 of the male terminal assembly 3100 to the end extent 3204 of the male terminal assembly 3100. Nevertheless, said interlocking member 3130 is still configured to prevent undesired mechanical or thermal expansion of the male terminal body 104.

The inclusion of the sidewall portions 3202a-3202d and the end extent 3204 forms a U-shaped structure 3206 that surrounds the contact arms 3180a-3180d. Said U-shaped structure 3206 protects the contact arms 3180a-3180d from accidental damage and increases the robustness of the male terminal assembly 3100 in comparison to another embodiment of a male terminal assembly that lacked said U-shaped structure 3206. Due to the inclusion of the U-shaped structure 3206, the male terminal assembly 3100 also includes contact arm apertures or openings 3170a-3170d are integrally formed in the terminal side wall 3132. In other words, the contact arm openings 3170a-3170d surround three sides of the contact arms 3180a-3180d in order to create a configuration that permits the contact arms 3180a-3180d not to be laterally connected to: (i) another contact arm 3180a-3180d or (ii) a structure other than the base portion 3110. As best shown in FIGS. 62-76, contact arm openings 3170a-3170d include: (i) lateral extents 3172a-3172h that extend along each elongated edge 3200a, 3200b of the contact arms 3180a-3180d, and (ii) frontal extents 3174a-3174d. For example, one contact arm opening 3170a includes: (i) a first lateral extent 3172a positioned between the contact arm 3180a and the first sidewall portion 3202a, (ii) a second lateral extent 3172b positioned between the contact arm 3180a and the second sidewall portion 3202b, and (iii) the first frontal extent 3174a.

As best shown in FIGS. 62-76, the contact arms 3180a-3180d extend: (i) from an extent of the base portion 3110, (ii) across an extent of the contact arm opening 3170a-3170d, and (iii) terminate before the end extent 3204 of the male terminal body 3104. This configuration is beneficial over the configuration of the terminals shown in FIGS. 9-15, 18, 21-31, 32, 41-42, 45-46, 48 and 50 in PCT/US2018/019787 because it allows for: (i) can be shorter in overall length, which means less metal material is needed for the formation and the male terminal 3104 can be installed in narrower, restrictive spaces, (ii) has a higher current carrying capacity, (iii) is easier to assemble, (iv) improved structural rigidity because the contact arms 3180a-3180d are positioned inside of the terminal side wall 3132, (iv) benefits that are disclosed in connection with PCT/US2019/036010, and (v) other beneficial features that are disclosed herein or can be inferred by one of ordinary skill in the art from this disclosure.

To integrally form the internal spring member 3350 as part of the male terminal body 3104, the entire body 3104 is formed from a cladded material. For example, the materials that may be used include: (i) copper clad steel (e.g., combination of copper and steel), (ii) copper and stainless steel, (iii) plating material (e.g., nickel), copper and steel or stainless steel, (iv) copper, steel or stainless steel, copper, (v) aluminum and steel, (vi) aluminum and stainless steel, (vii) plating material (e.g., nickel or copper), aluminum and steel or stainless steel, (viii) aluminum, steel or stainless steel, aluminum, or (ix) any combination of these materials or other similar materials. Additionally, as shown in 77A-77H, the thickness of the steel or stainless steel may be equal to the thickness of the copper or aluminum or the thickness of the steel or stainless steel may be greater than the thickness of the copper or aluminum. In further embodiments, the thickness of the steel or stainless steel may be less than the thickness of the copper or aluminum. It should be understood that in other embodiments, the only a portion (e.g., contact arms 3180a-3180d) of the body 3104 may be formed from a cladded material.

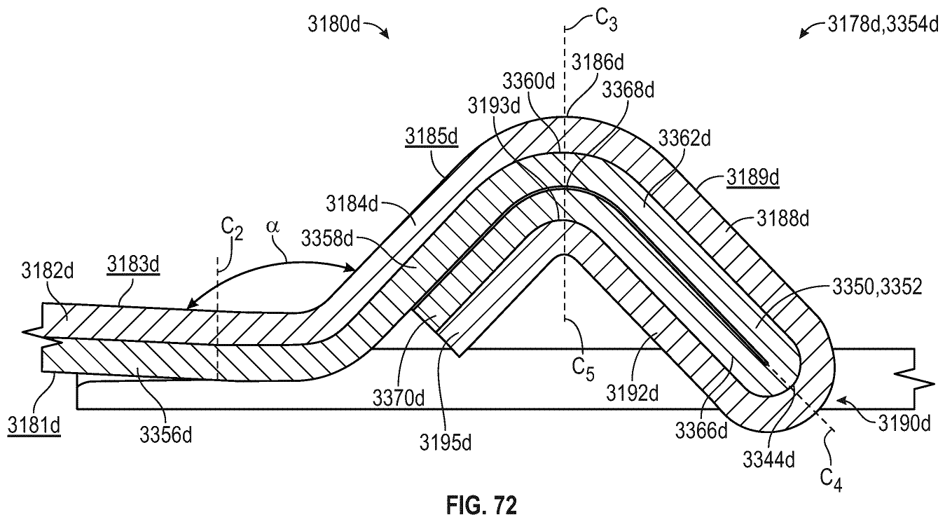

As shown in FIGS. 71-72, the male terminal assembly 3100 is made from a combination of copper and steel, where the copper is positioned on the exterior of the male terminal assembly 3100 and the steel is positioned on the interior of the male terminal assembly 3100. This configuration allows for a direct copper to copper connection between the male and female terminal assemblies 3100, 3700, when the connector system 3010 is in the connected state S_{CN}. Said direct copper to copper connection is desirable because of copper has a lower resistivity in comparison to the resistivity of steel. Also, positioning the steel on the inside of the copper will allow the steel to act as a support structure for the contact arm 3180a-3180d during operation of said connector system 3010.

Unlike the first embodiment disclosed herein, the configuration of the internal spring member 3350 matches the configuration of the contact arm 3180a-3180d. Accordingly, the spring arms 3352a-3352d have a folded or pleated portion 3354a-3354d that includes: (i) a first, rear, or linear extent 3356a-3356d that extends from the base or intermediate portion 3110 (line C₁), (ii) a second or upwardly sloping extent 3358a-3358d that extends between the first extent 3356a-3356d (line C₂) and an exterior apex 3360a-3360d of the spring arms 3352a-3352d (line C₃), (iii) a third or downwardly sloping extent 3362a-3362d that extends downward from an external apex 3360a-3360d (line C₃) to a forward-most extent that provides an internal nose 3364a-3364d (line C₄) with a rounded configuration, (iv) a fourth or rearwardly extending extent 3366a-3366d that extends rearward and upward from the internal nose 3364a-3364d (line C₄) to an interior apex 3368a-3368d (line C₅), and (v) a fifth or rearwardly angled extent 3370a-3370d that extends rearward from the interior apex 3368a-3368d (line C₅). The folded or pleated portion 3354a-3354d positions two spring layers adjacent to one another, while substantially encapsulating said layers with contact arm layers.

Also, unlike other conventional connections disclosed or incorporated herein, the spring biasing force F_{SB} exerted by the spring member 3350 on the contact arm 3180a-3180d is not only exerted on the free end or contact points. Instead, it is distributed across at least an extent of the contact arm 3180a-3180d. Also, by integrally forming the internal spring member 3350 as part of the male terminal body 3104, the contact arms 3180a-3180d are no longer supported by a separate component and instead are a cantilever. This cantilever configuration is different than the configurations shown in the applications incorporated herein by reference and is beneficial due to the extremely small size of this male terminal assembly 3100.

### 1) Alternate Embodiments of the Male Connector Assembly

FIG. 78 show a fifth embodiment of the male terminal assembly 4100. Because a substantial majority of the structures contacted in this embodiment 4100 are similar to the third embodiment 3100, it should be understood that reference numbers that are shown in the figures may be omitted from the specification for the sake of brevity, as like structures have like numbers. For example, the disclosure in connection with U-shaped structure 3206 is not repeated herein, but it applies to U-shaped structure 4206, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. Unlike the third embodiment, the configuration of the contact arms 4180a-4180d is substantially different, wherein the folded portion is omitted and replaced with a simpler curvilinear configuration.

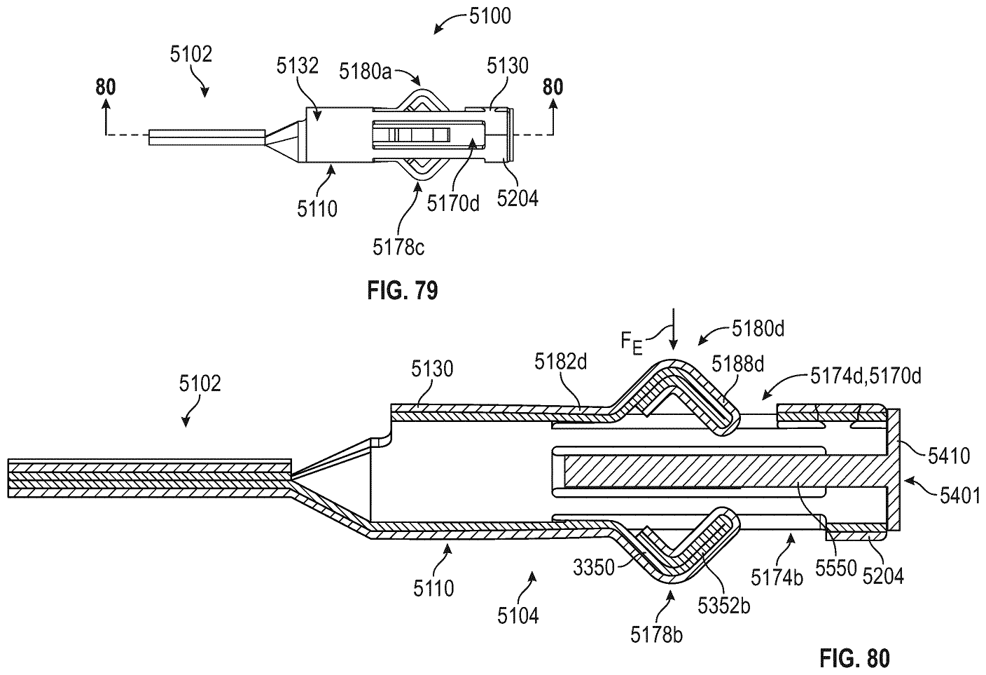

FIGS. 79-80 show a sixth embodiment of the male terminal assembly 5100. Because a substantial majority of the structures contacted in this embodiment 5100 are similar to the third embodiment 3100, it should be understood that reference numbers that are shown in the figures may be omitted from the specification for the sake of brevity, as like structures have like numbers. For example, the disclosure in connection with contact arms 3180a-3180d is not repeated herein, but it applies to contact arms 5180a-5180d, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. Unlike the fourth embodiment of the male terminal assembly 5100, this embodiment includes an insert (e.g., similar to the spring holder) with an over-travel or over-compression protection projection 5550. Said over-travel protection projection 5550 extends inward from the head portion 5410 of the insert 5401 and is configured to be positioned between the spring arms 5312a-5312d. The over-travel protection projection 5550 can have a cross-sectional shape of a circle, square, cross, or another other similar shape that will help prevent the contact arm 5180a-5180d from being over compressed due to an external force FE on the contact arms 5180a-5180d. This is desirable to increase the durability of the system 5010 because said over-travel protection projection 5550 will help prevent the contact arms 5180a-5180d from being deformed to a point that said structures cannot return to an original or near original state; thus, causing the system 5010 to suffer a critical failure.

### Related Information for the Systems

The system 10, 1010, 2010, 3010, 4010, and 5010 is compliant to T4/V4/D2/M2, wherein the system 10, 1010, 2010, 3010, 4010, and 5010 meets and exceeds: (i) T4 is exposure of the system 10 to 150° C., (ii) V4 is severe vibration, (iii) D2 is 200k mile durability, and (iv) M2 is less than 45 Newtons of force is required to connect the male terminal assembly 100, 1100, 2100, 3100, 4100, 5100 to the female terminal assembly 700, 1700, 2700, 3700, 4700, 5700. In addition to being T4/V4/D2/M2 compliant, the system 10, 1010, 2010, 3010, 4010, and 5010 is push, click, tug, scan (PCTS) compliant, wherein additional information about this standard is disclosed within PCT/US2020/049870.

It should be understood that the male terminal assemblies 100, 1100, 2100, 3100, 4100, 5100 and the female terminal assemblies 700, 1700, 2700, 3700, 4700, 5700 disclosed within this application having the following specifications regarding carrying at 55° C. rise over ambient (RoA) or 80° C. with a derating of 80%: (i) wherein the outside perimeter of the male terminal assembly 100, 1100, 2100, 3100, 4100, 5100 is 8 mm and its rated to carry 120 amps with a 16 mm² wire. Additionally, the system 10 meets the mile durability of USCAR-20, has a contact mating force that is between 10 Newtons and 30 Newtons, preferably 15 Newtons, has a un-mating force that may be larger than the mating force and is between 10 Newtons and 30 Newtons, preferably 18 Newtons, meet vibration standards of 31 Gs, and is ISL/TPA compatible. These substantial increases in current carrying capacity, while meeting the USCAR specifications provides considerable advantages of the prior art connectors. It should be understood that alternative configurations for male terminal assembles 100, 1100, 2100, 3100, 4100, 5100 are possible. For example, any number of male terminal assemblies 100, 1100, 2100, 3100, 4100, 5100 (e.g., between 2-30, preferably between 2-8, and most preferably between 2-4) may be positioned within a housing. Additionally, alternative configurations for female connector assembles 650, 1650, 2650, 3650, 4650, 5650 are possible. For example, the female connector assembly 650, 1650, 2650, 3650, 4650, 5650 may be reconfigured to accept these multiple male terminal assemblies 100, 1100, 2100, 3100, 4100, 5100 into a single female terminal assembly 700, 1700, 2700, 3700, 4700, 5700.

It should also be understood that the male terminal assemblies 100, 1100, 2100, 3100, 4100, 5100 may have any number of contact arms 180a-180d, 1180a-180d, 2180a-180d, 3180a-180d, 4180a-180d, 5180a-180d (e.g., between 2-100, preferably between 2-50, and most preferably between 2-8) and any number of spring arms 312a-312d, 1312a-1312d, 2312a-2312d, 3312-3312d, 4312-4312d, 5312-5312d (e.g., between 2-100, preferably between 2-50, and most preferably between 2-8). As discussed above, the number of contact arms 180a-180d, 1180a-180d, 2180a-180d, 3180a-180d, 4180a-180d, 5180a-180d may not equal the number of spring arms 312a-312d, 1312a-1312d, 2312a-2312d, 3312-3312d, 4312-4312d, 5312-5312d. For example, there may be more contact arms 180a-180d, 1180a-180d, 2180a-180d, 3180a-180d, 4180a-180d, 5180a-180d then spring arms 312a-312d, 1312a-1312d, 2312a-2312d, 3312-3312d, 4312-4312d, 5312-5312d. Alternatively, there may be less contact arms 180a-180d, 1180a-180d, 2180a-180d, 3180a-180d, 4180a-180d, 5180a-180d then spring arms 312a-312d, 1312a-1312d, 2312a-2312d, 3312-3312d, 4312-4312d, 5312-5312d.

Materials and Disclosure that are Incorporated by Reference

PCT Application Nos. PCT/US2022/037508, PCT/IB2022/057772, PCT/US2021/057959, PCT/US2021/047180, PCT/US2021/043788, PCT/US2021/043686, PCT/US2021/033446, PCT/US2020/050018, PCT/US2020/049870, PCT/US2020/014484, PCT/US2020/013757, PCT/US2019/036127, PCT/US2019/036070, PCT/US2019/036010, and PCT/US2018/019787, U.S. patent application Ser. No. 16/194,891 and U.S. Provisional Applications 63/286,072, and 63/286,080, each of which is fully incorporated herein by reference and made a part hereof.

SAE Specifications, including: J1742_201003 entitled, “Connections for High Voltage On-Board Vehicle Electrical Wiring Harnesses—Test Methods and General Performance Requirements,” last revised in March 2010, each of which is fully incorporated herein by reference and made a part hereof.

ASTM Specifications, including: (i) D4935-18, entitled “Standard Test Method for Measuring the Electromagnetic Shielding Effectiveness of Planar Materials,” and (ii) ASTM D257, entitled “Standard Test Methods for DC Resistance or Conductance of Insulating Materials,” each of which are fully incorporated herein by reference and made a part hereof.

American National Standards Institute and/or EOS/ESD Association, Inc Specifications, including: ANSI/ESD STM11.11 Surface Resistance Measurements of Static Dissipative Planar Materials, each of which is fully incorporated herein by reference and made a part hereof.

DIN Specification, including Connectors for electronic equipment-Tests and measurements—Part 5-2: Current-carrying capacity tests; Test 5b: Current-temperature derating (IEC 60512 May 2:2002), each of which are fully incorporated herein by reference and made a part hereof.

USCAR Specifications, including: (i) SAE/USCAR-2, Revision 6, which was last revised in February 2013 and has ISBN: 978-0-7680-7998-2, (ii) SAE/USCAR-12, Revision 5, which was last revised in August 2017 and has ISBN: 978-0-7680-8446-7, (iii) SAE/USCAR-21, Revision 3, which was last revised in December 2014, (iv) SAE/USCAR-25, Revision 3, which was revised on March 2016 and has ISBN: 978-0-7680-8319-4, (v) SAE/USCAR-37, which was revised on August 2008 and has ISBN: 978-0-7680-2098-4, (vi) SAE/USCAR-38, Revision 1, which was revised on May 2016 and has ISBN: 978-0-7680-8350-7, each of which are fully incorporated herein by reference and made a part hereof.

Other standards, including Federal Test Standard 101C and 4046, each of which is fully incorporated herein by reference and made a part hereof. While some implementations have been illustrated and described, numerous modifications come to mind without significantly departing from the spirit of the disclosure; and the scope of protection is only limited by the scope of the accompanying claims. For example, the overall shape of the of the components described above may be changed to: a triangular prism, a pentagonal prism, a hexagonal prism, octagonal prism, sphere, a cone, a tetrahedron, a cuboid, a dodecahedron, an icosahedron, an octahedron, a ellipsoid, or any other similar shape.

It should be understood that the following terms used herein shall generally mean the following:
a. “High power” shall mean (i) voltage between 20 volts to 600 volts regardless of current or (ii) at any current greater than or equal to 80 amps regardless of voltage.
b. “High current” shall mean current greater than or equal to 80 amps regardless of voltage.
c. “High voltage” shall mean a voltage between 20 volts to 600 volts regardless of current.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1.-64. (canceled)

65. An electrical connector assembly for use in a power distribution assembly, the connector assembly comprising:
a spring assembly including a spring member and a spring holder; and,
an electrically conductive male terminal body including a base portion and a plurality of contact arms extending from the base portion and being arrayed such that a void is defined between adjacent contact arms and no electrically conductive structure is located in the void between adjacent contact arms, and wherein the contact arms have a pleated portion where a first contact arm layer overlaps a second contact arm layer to provide both a frontal spring contact segment and an intermediate spring contact segment.

66. The electrical connector assembly of claim 65, wherein the base portion includes a side wall, and wherein the base portion includes an interlocking segment extending between a first portion of the side wall and a second portion of the side wall, wherein the interlocking segment is configured to limit movement of the male terminal body during operation of the electrical connector assembly.

67. The electrical connector assembly of claim 66, wherein the side wall defines an outer periphery of the base portion, and wherein the interlocking segment extends across a gap formed in the side wall, wherein a first end of the interlocking segment extends from the first portion of the side wall and a second end of the interlocking segment extends into an opening formed in a second portion of the side wall.

68-70. (canceled)

71. The electrical connector assembly of claim 65, wherein the frontal spring contact segment of the contact arm has a curvilinear end that engages a first portion of the spring member.

72. The electrical connector assembly of claim 65, wherein the intermediate spring contact segment of the contact arm has a planar end configuration that engages a second portion of the spring member.

73. The electrical connector assembly of claim 65, wherein the pleated portion of the contact arm also includes an internal apex, and wherein the intermediate spring contact segment extends inwardly from the internal apex.

74. The electrical connector assembly of claim 65, wherein the pleated portion of the contact arm provides both an external apex and an internal apex, wherein the external apex overlaps the internal apex.

75. The electrical connector assembly of claim 74, wherein the frontal spring contact segment of the contact arm has a curvilinear end that engages a first portion of the spring member, and wherein the external apex resides above said curvilinear end.

76. The electrical connector assembly of claim 65, wherein the base portion and the contact arms form a receptacle in the male terminal body, and wherein in an assembled state S_{A}, the spring member is inserted into the spring holder and both the spring holder and the spring member are positioned within said receptacle.

77. The electrical connector assembly of claim 76, wherein in the assembled state S_{A}, the frontal spring contact segment is a curvilinear frontal nose that engages a first portion of the spring member, and the intermediate spring contact segment is a planar end that engages a second portion of the spring member.

78. The electrical connector assembly of claim 76, wherein in the assembled state S_{A}, the frontal spring contact segment resides between the intermediate spring contact segment and a head portion of the spring holder.

79-83. (canceled)

84. The electrical connector assembly of claim 65, wherein the contact arms have an initial extent that is adjacent the base portion of the male terminal body, and wherein an outer surface of the base portion of the male terminal body is coplanar with an outer surface of said initial extent of the contact arm.

85. (canceled)

86. The electrical connector assembly of claim 76, wherein the base portion of the male terminal body includes at least one positioning projection that resides between a pair of contact arms, and wherein the positioning projection cooperatively interacts with at least one positioning rib of the spring holder in the assembled state S_{A}.

87. The electrical connector assembly of claim 65, wherein the spring holder includes: (a) a plurality of positioning ribs, (b) at least one spring aperture that resides between a pair of positioning ribs, and (c) at least one retaining means, and wherein the at least one spring aperture receives an extent of a spring arm of the spring member when the spring member is inserted into the spring holder.

88. The electrical connector assembly of claim 65, wherein the spring holder includes a head portion and a body portion that extends from the head portion, and wherein the head portion includes an outer, peripheral surface that is: (a) coplanar with an outer surface of the base portion of the male terminal body, and (b) flush with an initial extent of at least one of the plurality of contact arms.

89. The electrical connector assembly of claim 65, wherein the spring holder includes a head portion and a body portion that extends from the head portion, wherein the head portion has an outer periphery that defines an outer diameter of the spring holder, wherein the base portion of the male terminal body has an outer periphery that defines an outer diameter of the base portion, and wherein the outer diameter of the spring holder substantially equals an outer diameter of the base portion.

90. (canceled)

91. The electrical connector assembly of claim 76, wherein the spring holder includes a pair of positioning ribs, and wherein in the assembled state S_{A}, at least one of the plurality of contact arms is angularly located between the pair of positioning ribs.

92. The electrical connector assembly of claim 65, wherein in a coupled state S_{C}, (i) the spring member, the spring holder and the male terminal body are positioned within a male terminal housing, and (ii) an extent of the pleated portion of the contact arms extends through an opening formed in the male terminal housing, wherein the pleated portion of the contact arm provides an external apex, and wherein the external apex extends outward of the male terminal housing in the coupled state S_{C}.

93. (canceled)

94. The electrical connector assembly of claim 92, further comprising a female connector assembly that receives an extent of the male terminal body, the spring member and the male terminal housing in a connected state S_{CN}, and wherein the external apex makes contact with a female terminal assembly of the female connector assembly.

95. The electrical connector assembly of claim 92, further comprising a female connector assembly that receives an extent of the male terminal body, the spring member and the male terminal housing in a connected state S_{CN}, and wherein the female connector assembly applies an inwardly directed force on the external apex of the pleated portion of the contact arm.
